(19) United States
(12) Patent Application Publication
(10) Pub. No.: US 2026/0355631 A1
(43) Pub. Date: Nov. 12, 2026

(54) METHOD FOR CONTROLLING OBJECTS IN A VIRTUAL SCENE

(71) Applicant: TENCENT TECHNOLOGY (SHENZHEN) COMPANY LIMITED, Shenzhen (CN)

(72) Inventor: Yusheng MAO, Shenzhen (CN)

(73) Assignee: TENCENT TECHNOLOGY (SHENZHEN) COMPANY LIMITED, Shenzhen (CN)

(21) Appl. No.: 19/740,170

(22) Filed: Jul. 13, 2026

Related U.S. Application Data
(63) Continuation of application No. PCT/CN2025/084413, filed on Mar. 24, 2025.

(30) Foreign Application Priority Data
May 9, 2024 (CN) 202410574158.3

(51) Int. Cl. A63F 13/56; A63F 13/58; A63F 13/822

(52) U.S. Cl. CPC A63F 13/56; A63F 13/58; A63F 13/822

(57) ABSTRACT

In a virtual object-controlling method, a master virtual object and at least two battle virtual objects are displayed in a virtual scene. A first user input associated with a first attack operation for attacking at least a first virtual object of the at least two battle virtual objects is received. A second user input associated with a second attack operation is received. The second attack operation is configured to automatically determine a to-be-attacked battle virtual object within a first attack range. Based on the second attack operation, the master virtual object is displayed attacking a target virtual object of the at least two battle virtual objects based on whether the first virtual object is within the first attack range. The target virtual object includes the first virtual object or a different virtual object from the first virtual object.

### CROSS-REFERENCE TO RELATED APPLICATION

The present application is a continuation of International Application No. PCT/CN2025/084413, filed on Mar. 24, 2025, which claims priority to Chinese Patent Application No. 202410574158.3 filed on May 9, 2024. The entire disclosures of the prior applications are hereby incorporated by reference.

### FIELD OF THE TECHNOLOGY

Embodiments of this disclosure relate to the field of virtual environments, including a method and apparatus for controlling objects in a virtual scene, a device, a non-transitory computer-readable storage medium, and a product.

### BACKGROUND OF THE DISCLOSURE

Currently, in a game application, a player controls a master virtual object to perform a virtual battle with a battle virtual object controlled by another player, thereby implementing an interesting game process.

In related technology, when a player controls a master virtual object to attack a virtual object in a virtual scene with an attack skill, the player may launch a single attack to the virtual object by triggering the attack skill for a single time, or may launch a plurality of attacks to the virtual object by triggering the attack skill for many times. When a plurality of attacks is launched on the virtual object by a plurality of triggers, the attack process is generally automatically performed by selecting the virtual object with a minimum health point or the shortest distance.

Although the foregoing process may automatically determine a virtual object to be attacked, it may not take into account a previously attacked virtual object. Even if the automatic determination is performed with reference to the previously attacked virtual object, if the attack fails to hit the virtual object or hits a wrong virtual object, the player may not be able to perform a continuous attack on the desired virtual object, affecting attack accuracy and resulting in poor attack efficiency.

### SUMMARY

Embodiments of this disclosure include a method and apparatus for controlling objects in a virtual scene, a device, a non-transitory computer-readable storage medium, and a product, to flexibly select, in a case that a first attack operation and a second attack operation are successively received, a target virtual object to be attacked by a master virtual object based on the second attack operation in combination with a first virtual object targeted by the previous first attack operation of a player, thereby improving human-computer interaction efficiency.

The technical solutions of the embodiments of this disclosure may be implemented in the following manners.

An embodiment of this disclosure provides a virtual object-controlling method. In the virtual object-controlling method, a master virtual object and at least two battle virtual objects are displayed in a virtual scene. A first user input associated with a first attack operation for attacking at least a first virtual object of the at least two battle virtual objects is received. A second user input associated with a second attack operation is received. The second attack operation is configured to automatically determine a to-be-attacked battle virtual object within a first attack range. Based on the second attack operation, the master virtual object is displayed attacking a target virtual object of the at least two battle virtual objects based on whether the first virtual object is within the first attack range. The target virtual object includes the first virtual object or a different virtual object from the first virtual object.

An embodiment of this disclosure provides a virtual object-controlling apparatus. The virtual object-controlling apparatus includes processing circuitry configured to display a master virtual object and at least two battle virtual objects in a virtual scene. The processing circuitry is configured to receive a first user input associated with a first attack operation for attacking at least a first virtual object of the at least two battle virtual objects. The processing circuitry is configured to receive a second user input associated with a second attack operation, the second attack operation being configured to automatically determine a to-be-attacked battle virtual object within a first attack range. The processing circuitry is configured to display, based on the second attack operation, the master virtual object attacking a target virtual object of the at least two battle virtual objects based on whether the first virtual object is within the first attack range, the target virtual object including the first virtual object or a different virtual object from the first virtual object.

An embodiment of this disclosure provides a non-transitory computer-readable storage medium storing instructions which when executed by a processor cause the processor to perform the virtual object-controlling method.

According to an embodiment, a method for controlling objects in a virtual scene is provided. The method is performed by a computer device and includes: displaying a master virtual object and at least two battle virtual objects in a virtual scene, the master virtual object being configured to perform a virtual battle with the battle virtual objects in the virtual scene; receiving a first attack operation, the first attack operation being configured for attacking at least one first virtual object in the at least two battle virtual objects; receiving a second attack operation, the second attack operation corresponding to a first attack range, and the second attack operation being configured for automatically determining a to-be-attacked battle virtual object within the first attack range; and displaying, in response to the second attack operation, the master virtual object attacking a target virtual object in the at least two battle virtual objects based on a positional relationship between the first virtual object and the first attack range, the target virtual object being the same as the first virtual object, or the target virtual object being different from the first virtual object.

According to another embodiment, an apparatus for controlling objects in a virtual scene is provided. The apparatus includes: a display module, configured to display a master virtual object and at least two battle virtual objects in a virtual scene, the master virtual object being configured to perform a virtual battle with the battle virtual objects in the virtual scene; and a receiving module, configured to receive a first attack operation, the first attack operation being configured for attacking at least one first virtual object in the at least two battle virtual objects.

The receiving module is further configured to receive a second attack operation, the second attack operation corresponding to a first attack range, and the second attack operation being configured for automatically determining a to-be-attacked battle virtual object within the first attack range.

The display module is further configured to display, in response to the second attack operation, the master virtual object attacking a target virtual object in the at least two battle virtual objects based on a positional relationship between the first virtual object and the first attack range, the target virtual object being the same as the first virtual object, or the target virtual object being different from the first virtual object.

According to another embodiment, a computer device is provided. The computer device includes a processor and a memory. The memory has at least one instruction, at least one program, a code set, or an instruction set stored therein. The at least one instruction, the at least one program, the code set, or the instruction set is loaded and executed by the processor to implement the method for controlling objects in a virtual scene according to any one of the foregoing embodiments of this disclosure.

According to another embodiment, a non-transitory computer-readable storage medium is provided. The non-transitory computer-readable storage medium has at least one instruction, at least one program, a code set, or an instruction set. The at least one instruction, the at least one program, the code set, or the instruction set is loaded and executed by a processor to implement the method for controlling objects in a virtual scene according to any one of the foregoing embodiments of this disclosure.

According to another embodiment, a computer program product or a computer program is provided. The computer program product or the computer program includes computer instructions. The computer instructions are stored in a non-transitory computer-readable storage medium. A processor of a computer device reads the computer instructions from the non-transitory computer-readable storage medium, and the processor executes the computer instructions, to cause the computer device to perform the method for controlling objects in a virtual scene according to any one of the foregoing embodiments.

The technical solutions provided in the embodiments of this disclosure include at least the following beneficial effects:

A first attack operation for attacking a first virtual object in a plurality of battle virtual objects is received, and a second attack operation for automatically determining a battle virtual object is received, so as to display, based on a positional relationship between the first virtual object and a first attack range, a master virtual object attacking a target virtual object. When the first attack operation and a second attack operation are successively received, the target virtual object to be attacked by the master virtual object based on the second attack operation is flexibly selected according to a position situation of the first virtual object targeted by the first attack operation relative to the first attack range corresponding to the second attack operation. The target virtual object may be implemented as the first virtual object, or may be implemented as another battle virtual object other than the first virtual object. Thus, in combination with the first virtual object targeted by the previous first attack operation of a player, the target virtual object to be attacked may be automatically determined from the plurality of battle virtual objects in a selection manner more in line with player expectations, thereby improving the accuracy of selecting the target virtual object, helping avoid the cumbersome process of re-formulating combat policies in a case of low attack accuracy, saving computing resources during a game, helping achieve a low computing load even in large-scale virtual battles, helping ensure the accuracy and fluency of automatic object selection, and enhancing human-computer interaction efficiency during the game while improving the gaming experience of the player.

### BRIEF DESCRIPTION OF THE DRAWINGS

FIG. 1 is a structural block diagram of an electronic device according to an example embodiment of this disclosure.

FIG. 2 is a structural block diagram of a computer system according to an example embodiment of this disclosure.

FIG. 3 is a flowchart of a method for controlling objects in a virtual scene according to an example embodiment of this disclosure.

FIG. 4 is a flowchart of a method for controlling objects in a virtual scene according to another example embodiment of this disclosure.

FIG. 5 is a schematic diagram of a scene picture displaying a master virtual object in a virtual scene according to an example embodiment of this disclosure.

FIG. 6 is a schematic diagram of a scene picture displaying a master virtual object and a battle virtual object in a virtual scene according to an example embodiment of this disclosure.

FIG. 7 is a schematic diagram of an interface of performing a first trigger operation for a first attack control as a first attack operation according to an example embodiment of this disclosure.

FIG. 8 is a schematic diagram of an interface of performing a first trigger operation for a first attack control as a first attack operation according to another example embodiment of this disclosure.

FIG. 9 is a flowchart of a method for controlling objects in a virtual scene according to still another example embodiment of this disclosure.

FIG. 10 is a schematic diagram of an interface corresponding to a first attack operation according to an example embodiment of this disclosure.

FIG. 11 is a schematic diagram of an interface corresponding to a first attack operation according to another example embodiment of this disclosure.

FIG. 12 is a determining flowchart of determining a target virtual object based on a second attack operation according to an example embodiment of this disclosure.

FIG. 13 is a schematic diagram of an implementation process of a bullet skill according to an example embodiment of this disclosure.

FIG. 14 is a determining flowchart of determining a target virtual object based on a second attack operation in a marking range according to an example embodiment of this disclosure.

FIG. 15 is a schematic diagram of results corresponding to events occurring at different times and player operations according to an example embodiment of this disclosure.

FIG. 16 is a schematic diagram of an attack interface based on a first attack operation according to an example embodiment of this disclosure.

FIG. 17 is a schematic diagram of an attack interface based on a second attack operation according to an example embodiment of this disclosure.

FIG. 18 is a structural block diagram of an apparatus for controlling objects in a virtual scene according to an example embodiment of this disclosure.

FIG. 19 is a structural block diagram of an electronic device according to an example embodiment of this disclosure.

### DETAILED DESCRIPTION

Examples of terms involved in the embodiments of the disclosure are briefly introduced. The descriptions of the terms are provided as examples only and are not intended to limit the scope of the disclosure.

A virtual scene may be a virtual scene displayed (or provided) by an application when run on a terminal. The virtual scene may be a simulated scene of a real scene, or may be a semi-simulated semi-fictional scene, or may be an entirely fictional scene. The virtual scene may be any one of a two-dimensional virtual scene, a 2.5-dimensional virtual scene, or a three-dimensional virtual scene. This is not limited in this disclosure. The following embodiments are illustrated by taking the virtual scene as a three-dimensional virtual scene.

A virtual model may be a model used in the virtual scene to simulate a real scene. By way of example, the virtual model occupies a particular volume in the virtual scene. By way of example, the virtual model includes: a terrain model, a building model, an animal-plant model, a virtual item model, a virtual vehicle model, and a virtual object model. For example, the terrain model includes at least one of: ground, mountains, rivers, stones, steps, etc. The building model includes: houses, enclosures, containers, and fixed facilities inside buildings such as tables, chairs, cabinets, or beds. The animal-plant model includes at least one of: trees, flowers, birds, etc. The virtual item model includes at least one of: virtual attack items, medical kits, airdrops, etc. The virtual vehicle model includes at least one of: cars, ships, helicopters, etc. The virtual object model includes at least one of: characters, animals, animation characters, etc.

A virtual character/virtual object may refer to a movable object in the virtual scene. The movable object may be a virtual object, a virtual animal, or an animation character, such as a character, an animal, a plant, an oil drum, a wall, or a stone displayed in the three-dimensional virtual scene. In some embodiments, the virtual object is a three-dimensional model created based on a skeletal animation technology. Each virtual object has a shape and a volume in the three-dimensional virtual scene, and occupies a part of a space in the three-dimensional virtual scene.

In embodiments of this disclosure, a method for controlling objects in a virtual scene is provided, to flexibly select, in a case that a first attack operation and a second attack operation are successively received, a target virtual object to be attacked by a master virtual object based on the second attack operation in combination with a first virtual object targeted by the previous first attack operation of a player, thereby improving human-computer interaction efficiency. When a method for controlling objects in a virtual scene according to this disclosure is applied, at least one of various virtual scenes such as a virtual shooting scene and a virtual battle scene is provided. The foregoing disclosure scenes are only illustrative examples, and the method for controlling objects in a virtual scene according to this disclosure may be applied to other scenes. This is not limited in the embodiments of this disclosure.

In this disclosure, before collection of relevant data of the user and during the collection of the relevant data of the user, a prompt interface or a pop-up window may be displayed, or audio prompt information may be outputted. The prompt interface, the pop-up window, or the audio prompt information is configured for prompting the user that the relevant data of the user is currently searched for collection. In this way, in this disclosure, only after a confirmation operation transmitted by the user for the prompt interface or the pop-up window is obtained, a relevant operation of obtaining the relevant data of the user is started to be performed. Otherwise (in other words, the confirmation operation transmitted by the user for the prompt interface or the pop-up window is not obtained), the relevant operation of obtaining the relevant data of the user is ended, in other words, the relevant data of the user is not obtained. In other words, all user data collected by this disclosure is collected with the consent and authorization of the user, and the collection, use, and processing of user-related data need to comply with relevant laws, regulations, and standards of relevant regions.

A terminal in this disclosure may be a desktop computer, a laptop portable computer, a mobile phone, a tablet computer, an e-book reader, a moving picture experts group audio layer III (MP3) player, or a moving picture experts group audio layer IV (MP4) player. An application supporting a virtual environment, for example, an application supporting a three-dimensional virtual environment, is installed and run in the terminal. The application may be any one of a virtual reality (VR) application, a three-dimensional map program, a third-person shooting (TPS) game, a first-person shooting (FPS) game, or a multiplayer online battle arena (MOBA) game. In some embodiments, the application may be a standalone application, such as a standalone three-dimensional game program, or may be an online application.

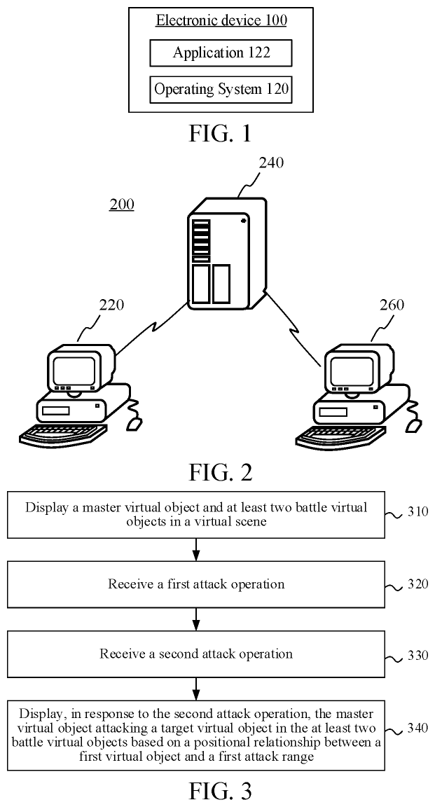

FIG. 1 shows a structural block diagram of an electronic device according to an example embodiment of this disclosure. The electronic device 100 includes: an operating system 120 and an application 122.

The operating system 120 is basic software that provides secure access to computer hardware for the application 122.

The application 122 is an application supporting a virtual environment. In some embodiments, the application 122 is an application supporting a three-dimensional virtual environment. The application 122 may be any one of a VR application, a three-dimensional map program, a TPS game, an FPS game, an MOBA game, or a multiplayer gunfight survival game. The application 122 may be a standalone application, such as a standalone three-dimensional game program, or may be an online application.

FIG. 2 shows a structural block diagram of a computer system according to an example embodiment of this disclosure. The computer system 200 includes: a first device 220, a server 240, and a second device 260.

An application supporting a virtual environment is installed and run on the first device 220. The application may be any one of a VR application, a three-dimensional map program, a TPS game, an FPS game, an MOBA game, or a multiplayer gunfight survival game. The first device 220 is a device used by a first user. The first user controls, by using the first device 220, an activity of a first virtual object located in a virtual environment. The activity includes, but is not limited to, at least one of adjusting a body posture, crawling, walking, running, riding, jumping, driving, picking up, shooting, attacking, or throwing. Schematically, the first virtual object is a first virtual character, such as a simulated character role or a cartoon character role.

The first device 220 is connected to the server 240 through a wireless network or a wired network.

The server 240 includes at least one of one server, a plurality of servers, a cloud computing platform, or a virtualization center. The server 240 is configured to provide a background service for an application supporting a three-dimensional virtual environment. In some embodiments, the server 240 undertakes main computing tasks, and the first device 220 and the second device 260 undertake secondary computing tasks. Alternatively, the server 240 undertakes secondary computing tasks, and the first device 220 and the second device 260 undertake main computing tasks. Alternatively, the server 240, the first device 220, and the second device 260 perform collaborative computing using a distributed computing architecture.

An application supporting a virtual environment is installed and run on the second device 260. The application may be any one of a VR application, a three-dimensional map program, an FPS game, an MOBA game, or a multiplayer gunfight survival game. The second device 260 is a device used by a second user. The second user controls, by using the second device 260, an activity of a second virtual object located in a virtual environment. The activity includes, but is not limited to, at least one of adjusting a body posture, crawling, walking, running, riding, jumping, driving, picking up, shooting, attacking, or throwing. Schematically, the second virtual object is a second virtual character, such as a simulated character role or a cartoon character role.

In some embodiments, the first virtual character and the second virtual character are located in the same virtual environment. In some embodiments, the first virtual character and the second virtual character may belong to the same team, the same organization, have a friendship, or have temporary communication rights. In some embodiments, the first virtual character and the second virtual character may alternatively belong to different teams, different organizations, or two hostile groups.

In some embodiments, the applications installed on the first device 220 and the second device 260 may be the same, or the applications installed on the two devices are the same type of applications on different control system platforms. The first device 220 may generally refer to one of a plurality of devices, and the second device 260 may generally refer to one of a plurality of devices. In this embodiment, only the first device 220 and the second device 260 are used as an example for description. Device types of the first device 220 and the second device 260 are the same or different. The device type includes: at least one of a game console, a desktop computer, a smartphone, a tablet computer, an e-book reader, an MP3 player, an MP4 player, or a laptop portable computer. The following embodiments are described by taking the device as a desktop computer.

A person skilled in the art may understand that more or fewer devices may be provided. For example, there may be only one device, or there may be dozens or hundreds of devices, or more devices. A quantity of devices and the device type are not limited in the embodiments of this disclosure.

The server 240 may be implemented as a physical server, or may be implemented as a cloud server in a cloud.

In some embodiments, the method provided in the embodiments of this disclosure may be applied to a cloud game scene, so that the cloud server completes calculation of data logic in a game process, and a terminal is responsible for displaying a game interface.

The method for controlling objects in a virtual scene according to this disclosure is described with reference to the foregoing terminology introduction and disclosure scenes. The method is described by being applied to a terminal. As shown in FIG. 3, the method includes the following operation 310 to operation 340.

Operation 310: Display a master virtual object and at least two battle virtual objects in a virtual scene.

In some embodiments, the virtual scene is implemented as a game scene in a game application.

Schematically, a game application is installed on a terminal, and a game screen during the running of the game application is displayed on a screen of the terminal. The game screen is a virtual scene in a game.

In some embodiments, the virtual scene is implemented as a scene displayed under a VR or augmented reality (AR) technology.

Schematically, under the VR technology, a computer-generated virtual world or the screen displayed on the terminal may be projected into a three-dimensional space through a head-mounted display (e.g., a VR helmet or VR glasses), so as to display the virtual scene.

Schematically, under the AR technology, the virtual scene may be displayed by means of the terminal (e.g., a smartphone, a tablet computer, or dedicated AR glasses). For example, when a user starts a camera in an AR application installed on the terminal, the terminal captures a video image of the real world and superimposes virtual content thereon, thereby displaying the virtual scene.

In some embodiments, the virtual scene includes a master virtual object and at least two battle virtual objects.

Schematically, the master virtual object is configured to represent a virtual object operated by a player, and the battle virtual objects are virtual objects performing virtual battle with the master virtual object. To be specific, the master virtual object is configured to launch a virtual battle with the battle virtual objects in the virtual scene.

In some embodiments, the battle virtual objects are implemented as enemy virtual objects belonging to a different virtual camp from the master virtual object.

Schematically, the master virtual object is in virtual camp 1, which includes a plurality of teammate virtual objects including the master virtual object. At least one other virtual camp, such as virtual camp 2, launches a virtual battle with virtual camp 1, and virtual objects in virtual camp 2 are referred to as enemy virtual objects. Therefore, the enemy virtual objects launching a virtual battle with the master virtual object are the battle virtual objects.

In some embodiments, the battle virtual objects are implemented as pre-configured non-player characters (NPC).

Schematically, the battle virtual objects are implemented as virtual soldiers, virtual monsters, and the like configured during the game to attack a plurality of virtual objects including the master virtual object.

Operation 320: Receive a first attack operation. For example, a first user input associated with a first attack operation for attacking at least a first virtual object of the at least two battle virtual objects is received.

In some embodiments, during the process of controlling the master virtual object to launch a virtual battle with at least two battle virtual objects, the master virtual object may be controlled to move in the virtual scene by means of walking, running, crawling forward, and the like through an object movement operation. The master virtual object may alternatively be controlled to pick up virtual items, virtual costumes, and the like in the virtual scene through an item pickup operation. The master virtual object may alternatively be controlled to equip virtual items, adjust skins of virtual items, and the like through an item configuration operation. The master virtual object may alternatively be controlled to attack battle virtual objects in the virtual scene through an attack operation.

Schematically, an attack operation is an operation for weakening object attributes of a battle virtual object, where the object attributes are attributes on which the virtual object depends for survival in the virtual scene. For example, the object attributes include at least one of virtual health points, virtual mana points, virtual attack power, virtual defense power, virtual speed, and other attributes.

In some embodiments, the terminal receives a first attack operation based on an operation of a player on the terminal. As one type of attack operation, the first attack operation may inflict a virtual damage on battle virtual objects in the virtual scene.

The first attack operation is configured for attacking at least one first virtual object in the at least two battle virtual objects.

In some embodiments, the first virtual object is a battle virtual object independently selected by the player from the at least two battle virtual objects.

Schematically, the player may implement the first attack operation through control 1, where control 1 has a direction indication function. The player may point an attack direction toward the first virtual object when using control 1, so that a targeted attack on the first virtual object may be implemented when triggering control 1 to perform the first attack operation. Alternatively, the player may point the attack direction toward a range where the first virtual object is located when using control 1, so that a targeted attack on at least one first virtual object within the range may be implemented when triggering control 1 to perform the first attack operation.

In some embodiments, the first virtual object is a battle virtual object selected by default by the terminal from the at least two battle virtual objects based on the operation of the player.

Schematically, the player may perform the first attack operation through control 1. Based on a trigger operation of the player, control 1 automatically determines at least one battle virtual object as the first virtual object from a nearby range corresponding to the master virtual object. For example, a battle virtual object with a minimum virtual health point is taken as the first virtual object. Alternatively, a plurality of battle virtual objects with the minimum virtual health point are taken as the first virtual object. Alternatively, at least one battle virtual object with the shortest distance is taken as the first virtual object. Thus, the first attack operation targeting the first virtual object is implemented based on the trigger operation on control 1 and the first virtual object selected by default.

Operation 330: Receive a second attack operation. For example, a second user input associated with a second attack operation is received, the second attack operation being configured to automatically determine a to-be-attacked battle virtual object within a first attack range.

Schematically, after receiving the first attack operation, a second attack operation may be received. To be specific, the second attack operation is an attack operation following the first attack operation. As one type of attack operation, the second attack operation may inflict a virtual damage on battle virtual objects in the virtual scene.

In some embodiments, the second attack operation and the first attack operation are operations of different attack types.

Schematically, the first attack operation is an operation of controlling the master virtual object to attack the first virtual object using a first skill, and the second attack operation is an operation of controlling the master virtual object to attack a battle virtual object using a second skill. The first skill and the second skill are different attack skills. For example, the first skill is a shooting skill and the second skill is an explosive throwing skill. Therefore, the first attack operation and the second attack operation are operations for implementing different attack types.

In some embodiments, the second attack operation and the first attack operation are operations of the same attack type.

Schematically, the first attack operation is an operation of controlling the master virtual object to attack the first virtual object through skill control 1, and the second attack operation is an operation of continuing to use skill control 1 to control the master virtual object to attack a battle virtual object. The first attack operation and the second attack operation may be understood as attack operations for attacking battle virtual objects at different times using the same skill control.

Therefore, the first attack operation and the second attack operation may be referred to as a combo attack process. For example, the first attack operation is first received to attack the first virtual object in the virtual scene, and then the second attack operation is received to automatically determine and attack a battle virtual object from the virtual scene.

In some embodiments, after receiving the first attack operation, the terminal needs to inflict a virtual damage on the first virtual object based on the first attack operation. There is an attack interval period during the process from receiving the first attack operation to inflicting a virtual damage on the first virtual object. As an attack operation following the first attack operation, the second attack operation may be either an attack operation received during the attack interval period or an attack operation received after the first attack operation has inflicted a virtual damage on the first virtual object. This is not limited herein.

The second attack operation corresponds to a first attack range.

In some embodiments, each attack operation corresponds to an attack range. The attack range represents a region range where a virtual damage is inflicted by the attack operation. Therefore, the first attack range is configured for representing a region range where a virtual damage is inflicted based on the second attack operation.

Schematically, the first attack range is implemented as a rectangular region range determined based on the second attack operation. Alternatively, the first attack range is implemented as a circular region range determined based on the second attack operation. Alternatively, the first attack range is implemented as an irregular region range determined based on the second attack operation.

In some embodiments, the first attack range is a region range determined based on an attack skill adopted in the second attack operation.

Schematically, different attack skills correspond to different attack ranges. If the second attack operation is implemented based on triggering attack skill 1, an attack range corresponding to attack skill 1 is taken as the first attack range corresponding to the second attack operation.

For example, the second attack operation is an attack operation implemented by triggering attack skill 1, where attack skill 1 is configured for attacking battle virtual objects within a preset region toward which the master virtual object is facing. For example, the preset region is a rectangular region of a preset area formed with the position of the master virtual object as a boundary point. The preset region is the attack range corresponding to attack skill 1 and also the first attack range corresponding to the second attack operation.

The second attack operation is configured for automatically determining a to-be-attacked battle virtual object within the first attack range.

Schematically, the second attack operation is an attack operation that automatically determines the to-be-attacked battle virtual object.

In some embodiments, the attack operation is implemented in at least one of the following attack forms.

### (1) First Attack Form with a Specified Attack Object

Schematically, if the attack operation is implemented as a first attack form with a specified attack object, it indicates that the attack operation of the first attack form is a directional operation. Therefore, the attack operation of the first attack form is configured for attacking the battle virtual object designated by the player. For example, the player selects battle virtual object A as an attack object and performs an attack operation for battle virtual object A, and the attack form of the attack operation is the first attack form.

### (2) Second Attack Form with an Automatically Determined Attack Object

Schematically, if the attack operation is implemented as a second attack form with an automatically determined attack object, it indicates that the attack operation of the second attack form is a directional operation that does not require the player to designate an object but needs to automatically determine the attack object. Therefore, the attack operation of the second attack form is configured for first automatically determining the battle virtual object to be attacked as the attack object, and then attacking the automatically determined battle virtual object. For example, the player triggers a control capable of automatically determining an attack object to implement an attack operation. Since the attack operation belongs to the second attack form, the battle virtual object to be attacked is first automatically determined from an attack range corresponding to the attack operation, and then the battle virtual object is attacked.

### (3) Third Attack Form with any Attack Object

Schematically, if the attack operation is implemented as a third attack form with any attack object, it indicates that the attack operation of the third attack form is an operation that does not require the player to designate an object and determine an attack object in a targeted manner. Therefore, the attack operation of the third attack form may perform indiscriminate attacks on battle virtual objects within the corresponding attack range. For example, the player triggers a normal attack control to implement an attack operation, and the attack operation of the third attack form launches indiscriminate attacks on battle virtual objects within the attack range, such as inflicting an equal virtual damage on a plurality of battle virtual objects within the attack range.

The foregoing descriptions are only illustrative examples. This is not limited in the embodiments of this disclosure.

Operation 340: Display, in response to the second attack operation, the master virtual object attacking a target virtual object in the at least two battle virtual objects based on a positional relationship between a first virtual object and a first attack range. For example, based on the second attack operation, the master virtual object is displayed attacking a target virtual object of the at least two battle virtual objects based on whether the first virtual object is within the first attack range, the target virtual object including the first virtual object or a different virtual object from the first virtual object.

Schematically, upon receiving the second attack operation, an object position corresponding to the first virtual object is determined, and a relative positional relationship between the object position and the first attack range is determined, so as to automatically determine the target virtual object to be attacked in the second attack operation from the at least two battle virtual objects based on the relative positional relationship.

The object position is configured for representing position information of the first virtual object relative to the virtual scene. Since the first attack range is implemented as a region range in the virtual scene, a position situation of the first virtual object relative to the first attack range may be determined by combining the object position and the first attack range.

In some embodiments, the first virtual object is located within the first attack range, or the first virtual object is located outside the first attack range.

The first virtual object is a battle virtual object targeted by the first attack operation. When the second attack operation is received and the target virtual object is determined, the first virtual object may have been already inflicted with a virtual damage based on the first attack operation, or may not have been inflicted with a virtual damage based on the first attack operation. Therefore, when the first virtual object is within the first attack range, the following two cases may exist: the first virtual object that has not been inflicted with a virtual damage based on the first attack operation is within the first attack range, and the first virtual object that has been inflicted with a virtual damage based on the first attack operation is within the first attack range.

The target virtual object is the same as the first virtual object, or the target virtual object is different from the first virtual object.

Schematically, as a battle virtual object determined from the at least two battle virtual objects, the target virtual object may be implemented as the first virtual object targeted by the first attack operation (i.e., the target virtual object is the same as the first virtual object), or may be implemented as another virtual object other than the first virtual object (i.e., the target virtual object is different from the first virtual object).

In some embodiments, when the first virtual object is within the first attack range, at least one first virtual object is taken as the target virtual object, and the master virtual object attacking the target virtual object is displayed. Schematically, the case that the master virtual object attacks the target virtual object is presented in the form of a first attack animation. To be specific, the first attack animation is an attack animation of the master virtual object attacking the target virtual object.

Schematically, if the second attack operation is received after the first attack operation inflicts a virtual damage on the first virtual object, the positional relationship between the first virtual object and the first attack range corresponding to the second attack operation is determined based on the second attack operation. If the first virtual object is within the first attack range, the first virtual object may be taken as the target virtual object. To be specific, the first virtual object is taken as the battle virtual object to be attacked, which is automatically determined based on the second attack operation. Then, the master virtual object attacking the target virtual object may be displayed.

Alternatively, if the first virtual object is within the first attack range, a battle virtual object with a minimum virtual health point may be determined as the target virtual object from the at least one first virtual object. To be specific, the first virtual object with the minimum virtual health point is taken as the battle virtual object to be attacked, which is automatically determined based on the second attack operation. Then, the master virtual object attacking the target virtual object may be displayed.

Alternatively, if the first virtual object is within the first attack range, a battle virtual object closest to the master virtual object may be determined as the target virtual object from the at least one first virtual object. To be specific, the first virtual object closest to the master virtual object is taken as the battle virtual object to be attacked, which is automatically determined based on the second attack operation. Then, the master virtual object attacking the target virtual object may be displayed.

In some embodiments, when the first virtual object is not within the first attack range, at least one first virtual object is taken as the target virtual object, and the master virtual object attacking the target virtual object is displayed.

Schematically, if the second attack operation is received after the first attack operation inflicts a virtual damage on the first virtual object, the positional relationship between the first virtual object and the first attack range corresponding to the second attack operation is determined based on the second attack operation. If the first virtual object is not within the first attack range, the first virtual object outside the first attack range cannot be attacked based on the second attack operation, so that the battle virtual object to be automatically attacked needs to be determined as the target virtual object from the battle virtual objects within the first attack range. To be specific, the target virtual object to be attacked is determined from the battle virtual objects within the first attack range, and the target virtual object is a different battle virtual object from the first virtual object. Then, the master virtual object attacking the target virtual object may be displayed. For example, all battle virtual objects within the first attack range are taken as target virtual objects. Alternatively, the battle virtual object with the minimum virtual health point is taken as the target virtual object from at least one battle virtual object within the first attack range. Alternatively, the battle virtual object closest to the master virtual object is taken as the target virtual object from at least one battle virtual object within the first attack range.

The foregoing descriptions are only illustrative examples. This is not limited in the embodiments of this disclosure.

In summary, when a first attack operation and a second attack operation are successively received, a target virtual object to be attacked by a master virtual object based on a second attack operation may be flexibly selected according to a position situation of a first virtual object targeted by a first attack operation relative to a first attack range corresponding to the second attack operation. The target virtual object may be implemented as a first virtual object, or may be implemented as another battle virtual object other than the first virtual object. Thus, in combination with the first virtual object targeted by the previous first attack operation of a player, the target virtual object to be attacked may be automatically determined from a plurality of battle virtual objects in a manner more in line with player expectations, thereby improving the accuracy of selecting the target virtual object, saving computing resources during a game, helping ensure the precision and fluency of automatic object selection, and enhancing human-computer interaction efficiency during the game while improving the gaming experience of the player.

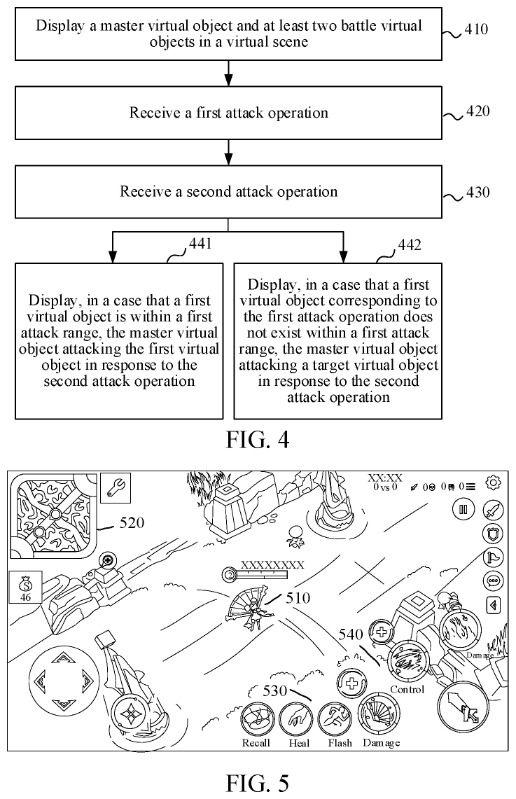

In an embodiment, as shown in FIG. 4, the following differences are described according to a relative position situation between the first virtual object and the first attack range. The embodiment shown in FIG. 3 may be further implemented as the following operation 410 to operation 442, where operation 340 may be implemented as either operation 441 or operation 442.

Operation 410: Display a master virtual object and a plurality of battle virtual objects in a virtual scene.

The master virtual object is configured to perform a virtual battle with the battle virtual objects in the virtual scene.

Schematically, the displayed virtual scene includes a master virtual object controlled by a player, as well as at least two battle virtual objects that engage in virtual battle with the master virtual object.

In some embodiments, the virtual scene adopts a third-person perspective, so that the master virtual object and the at least two battle virtual objects are visually presented in the virtual scene. Alternatively, the virtual scene adopts a first-person perspective, so that the virtual scene is a scene observed by the master virtual object, including battle virtual objects representative of battle virtual objects observed by the master virtual object.

In some embodiments, the master virtual object in the virtual scene is displayed, and the at least two battle virtual objects may be displayed as the master virtual object moves.

For example, when displaying the virtual scene, a virtual region of a preset area centered on the master virtual object is displayed. When a battle virtual object is within the virtual region, both the master virtual object and the battle virtual object in the virtual scene are displayed. When no battle virtual object is included within the virtual region corresponding to the master virtual object, only the master virtual object in the virtual scene is displayed until a battle virtual object exists in the virtual region, and both the master virtual object and the battle virtual object in the virtual scene are displayed.

FIG. 5 shows a schematic diagram of a scene picture displaying a master virtual object in a virtual scene. A master virtual object 510 and a virtual map 520 for displaying a global virtual scene are included. In addition, a plurality of functional controls are further included. For example, different attribute controls 530 are configured for applying bonuses of different forms to object attributes of the master virtual object. Alternatively, different attack controls 540 are configured for controlling the master virtual object to perform different types of attacks on battle virtual objects.

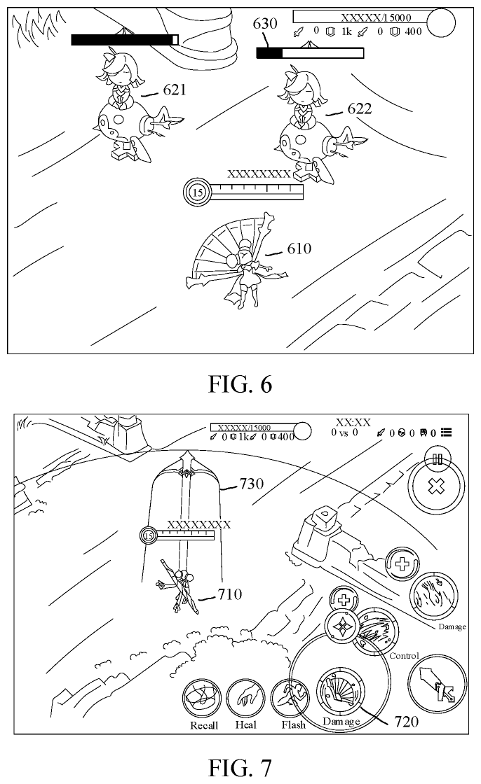

FIG. 6 shows a schematic diagram of a scene picture displaying a master virtual object and a battle virtual object in a virtual scene. A master virtual object 610 and two battle virtual objects, namely a battle virtual object 621 and a battle virtual object 622 are included. Therefore, the master virtual object 610 may launch a virtual battle with the battle virtual object 621 and the battle virtual object 622 in a virtual scene. For example, a player controls the master virtual object 610 to attack the battle virtual object 621 and/or the battle virtual object 622. Alternatively, the player controls the master virtual object 610 to defend against attacks from the battle virtual object 621 and/or the battle virtual object 622.

Operation 420: Receive a first attack operation.

The first attack operation is configured for attacking at least one first virtual object in the at least two battle virtual objects.

Schematically, the first attack operation is a directional attack operation, and the first attack operation targets the first virtual object, which means attacking the first virtual object in a targeted manner.

In some embodiments, the first attack operation is implemented as an attack operation targeting the first virtual object based on the player selecting a battle virtual object. Alternatively, the first attack operation is implemented as an attack operation targeting the first virtual object based on selecting a battle virtual object according to a screening rule.

Schematically, when the player selects a battle virtual object while performing the first attack operation, the battle virtual object is taken as the first virtual object targeted by the first attack operation.

Schematically, when the player does not select a battle virtual object while performing the first attack operation, the terminal automatically determines the first virtual object targeted by the first attack operation from a plurality of battle virtual objects based on a preset screening rule at the first attack operation. To be specific, the screening rule is a preset rule for selecting the attacked first virtual object from the battle virtual objects.

In some embodiments, the first attack operation corresponds to a second attack range. The preset screening rule is to select a battle virtual object with a minimum virtual health point as the first virtual object to be attacked. After receiving the first attack operation, the terminal may determine the battle virtual object with the minimum virtual health point from the second attack range as the first virtual object, thereby determining the first virtual object targeted by the second attack operation.

The second attack range is configured for representing a region range where a virtual damage is inflicted based on the first attack operation. To be specific, a virtual damage may be inflicted on at least one battle virtual object within the second attack range based on the first attack operation. For example, a virtual damage is inflicted on the first virtual object within the second attack range.

In an embodiment, a first trigger operation for a first attack control is received as the first attack operation.

The first attack control has an object designation function. The object designation function is configured for designating the first virtual object from at least two battle virtual objects.

Schematically, the first attack control is an attack control with an object designation function, which means that a virtual attack may be launched through the first attack control, and a battle virtual object targeted by the virtual attack may be determined through the first control, so as to perform an attack process on the selected battle virtual object in a targeted manner. When the first trigger operation on the first attack control is implemented as the first attack operation, the battle virtual object targeted by the object designation function of the first attack control is the first virtual object.

The first trigger operation is an operation of attacking the first virtual object based on the object designation function.

Schematically, the first trigger operation is implemented as a drag operation for the first attack control. A battle virtual object in a direction indicated by the drag operation is the first virtual object, so as to attack the first virtual object after the drag operation ends. The first trigger operation is implemented as a slide operation for the first attack control. A battle virtual object within a region (which may alternatively be regarded as the second attack range) indicated by the slide operation is the first virtual object, so as to attack the first virtual object after the slide operation ends. Alternatively, the first trigger operation is implemented as a double-click/tap operation for the first attack control. A battle virtual object in an orientation direction of the master virtual object under the double-click/tap operation is the first virtual object, so as to attack the first virtual object after the double-click/tap operation ends.

FIG. 7 shows a schematic diagram of an interface of performing a first trigger operation for a first attack control as a first attack operation. A master virtual object 710 is located in a virtual scene, and a slide operation is performed on a first attack control 720 to adjust an indication direction 730 of a first attack operation, so that after the slide operation on the first attack control 720 ends, a battle virtual object within a second attack range and in the indication direction 730 may be taken as a first virtual object targeted by the first attack operation, to implement a targeted attack on the first virtual object.

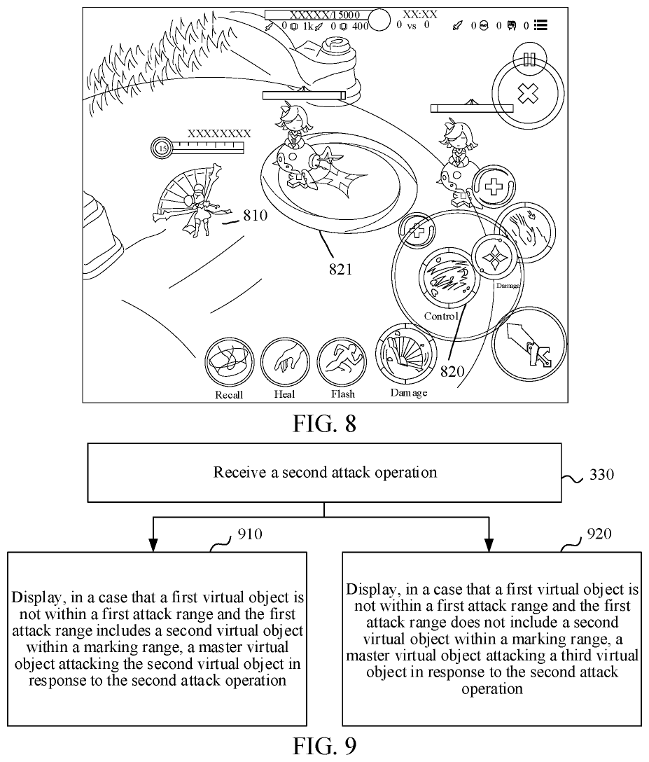

FIG. 8 shows a schematic diagram of another interface of performing a first trigger operation for a first attack control as a first attack operation. A master virtual object 810 is located in a virtual scene, a drag operation is performed on a first attack control 820 to adjust an indication region 821 of a first attack operation, and the indication region 821 corresponds to the first attack control 820, so that after the drag operation on the first attack control 820 ends, at least one battle virtual object within a second attack range (e.g., within the indication region 821) may be taken as a first virtual object targeted by the first attack operation, to implement a targeted attack on the first virtual object.

In the foregoing process, there is a corresponding relationship between an attack control and an attack range. For example, a plurality of attack controls in a game correspond to one attack range respectively. A first attack control is implemented as any attack control among the plurality of attack controls. When a first virtual object is determined by performing a first trigger operation on the first attack control, a position of the attack range relative to a virtual scene may be changed through flexible adjustment of the first attack control. For example, a rectangular region facing forward from a master virtual object is adjusted to a rectangular region facing right from the master virtual object. Alternatively, a circular region centered on point A is changed to a circular region centered on point B. This is not limited herein.

In an embodiment, a second trigger operation for the first attack control is received as the first attack operation.

The second trigger operation is an operation of automatically determining the first virtual object by using the first attack control.

Schematically, although the first attack control is a control with an object designation function, for the convenience of flexible operations of a player in a game, the first attack control may be endowed with a particular object selection function. Thus, when some simple operations are performed on the first attack control, the first attack control may be triggered to automatically determine the first virtual object to be attacked by the first attack operation based on the object selection function.

In some embodiments, a single-click/tap operation on the first attack control is taken as the second trigger operation to trigger the object selection function corresponding to the first attack control, so that the terminal may automatically determine the first virtual object from a plurality of battle virtual objects.

For example, all battle virtual objects within a second attack region corresponding to the first attack control are taken as the first virtual object. Alternatively, a battle virtual object with a minimum virtual health point within the second attack region is taken as the first virtual object. Alternatively, a battle virtual object closest to the master virtual object within the second attack region is taken as the first virtual object.

The foregoing content introduces two schematic implementation forms of the first attack operation. The first attack operation may be an attack operation implemented through the first trigger operation on the first attack control based on the object designation function, so that the attacked first virtual object may be designated from a plurality of battle virtual objects by means of the object designation function, thereby improving the pertinence and personalization of object attacks, and helping ensure the sense of participation and immersion of the player. In addition, the first attack operation may be implemented through the second trigger operation on the first attack control, thereby realizing an efficient selection process of battle virtual objects, reducing the operation burden of the player, flexibly adapting to combat requirements of different virtual battles, and improving resource utilization efficiency. Different object selection manners can be realized by adopting different trigger operations for the first attack control, the flexibility of virtual attacks can be improved while helping achieve the realization of virtual attacks, and a more optimized combat policy can be realized by combining the foregoing.

In an embodiment, the master virtual object attacking the first virtual object is displayed based on the first attack operation.

Schematically, the case that the master virtual object attacks the first virtual object is presented in a form of a second attack animation. Different from the first attack animation in which the master virtual object attacks the target virtual object based on the first attack operation, the second attack animation herein is an attack animation displayed based on the first attack operation, and the second attack animation describes a case that the master virtual object attacks the first virtual object.

Displaying the corresponding attack case under the first attack operation in the foregoing content may provide richer visual feedback and increase the interestingness and attractiveness of the game. In addition, displaying a corresponding attack manner based on the first attack operation may further help the player better understand and use various attack policies and adapt to different combat scenes. Furthermore, the intuitive attack feedback displayed in the attack process also helps to make the attack process smoother and more natural, attract the player to explore and try different attack policies, and improve the challenge of the game and human-computer interaction efficiency.

The foregoing descriptions are only illustrative examples. This is not limited in the embodiments of this disclosure.

Operation 430: Receive a second attack operation.

The second attack operation corresponds to a first attack range. Schematically, the first attack range is configured for representing a region range where a virtual damage is inflicted based on the second attack operation.

The second attack operation is configured for automatically determining a to-be-attacked battle virtual object within the first attack range.

Schematically, the second attack operation is not an attack operation in which the player independently determines a battle virtual object to be attacked, but an attack operation in which the terminal automatically determines a to-be-attacked battle virtual object based on a current virtual battle form.

In some embodiments, a trigger operation for a second attack control is received as the second attack operation.

The second attack control may be implemented as the foregoing first attack control, or as another attack control. At least one of various trigger operations such as a click/tap operation, a long-press operation, a drag operation, and a slide operation is performed on the second attack control, so as to implement a process of automatically determining the to-be-attacked battle virtual object.

Schematically, when the second attack control is implemented as the foregoing first attack control with the object designation function, the trigger operation for the second attack control is implemented as an operation for triggering the object selection function of the first attack control. To be specific, the second attack control is triggered to automatically determine the to-be-attacked battle virtual object in the second attack operation based on the object selection function.

Schematically, when the second attack control is implemented as another attack control other than the first attack control, the other attack control is also an attack control that needs to have an object designation function, so as to automatically determine the to-be-attacked battle virtual object in the second attack operation based on the object selection function.

In an embodiment, the second attack operation is received within a preset time period after the first attack operation is received.

Schematically, the preset time period may be used as a condition for determining a to-be-attacked object in the second attack operation by means of the first virtual object. To be specific, if the second attack operation is received within the preset time period after the first attack operation, the first virtual object corresponding to the first attack operation may be comprehensively considered when automatically determining the to-be-attacked object in the second attack operation. If the second attack operation is received after the preset time period, the first virtual object is not used as a consideration condition for the to-be-attacked object in the second attack operation.

For example, the preset time period is a time period of 2 seconds, 3 seconds, 5 seconds, 10 seconds, or the like starting from the reception of the first attack operation.

In some embodiments, if the second attack operation is received within the preset time period, the first attack operation and the second attack operation are regarded as combo attack operations, where the second attack operation is an attack operation to be analyzed, and the first attack operation may be implemented as at least one attack operation prior to the second attack operation.

Schematically, for example, a first attack operation is received at time 0, a preset time period is 3 seconds, and a second attack operation is received at 2 seconds. Then, the first attack operation and the second attack operation may be collectively referred to as a combo attack operation. Alternatively, for example, an initial first attack operation is received at time 0, a preset time period is 3 seconds, a second first attack operation is received at 0.5 seconds, a third first attack operation is received at 1.5 seconds, and a second attack operation is received at 2.5 seconds. Then, the three first attack operations and the second attack operation may be collectively referred to as a combo attack operation.

In some embodiments, for example, the second attack operation is received within the preset time period following the first attack operation. The second attack operation may be an operation received when the master virtual object is at an object position (where the object position is a position of the master virtual object in the virtual scene when the first attack operation is received), or an operation received after the master virtual object moves.

Schematically, the master virtual object is at position A when the first attack operation is received, and the master virtual object is also at position A when the second attack operation is received. Alternatively, the master virtual object is at position A when the first attack operation is received, and the master virtual object moves to position B when the second attack operation is received. To be specific, the object position of the master virtual object may change or remain unchanged when the first attack operation and the second attack operation are received.

Similarly, the second attack operation may be an operation received when the master virtual object corresponds to a first orientation, or an operation received when the master virtual object corresponds to a second orientation.

Schematically, the first orientation corresponding to the master virtual object is east when the first attack operation is received, and the master virtual object also corresponds to the first orientation when the second attack operation is received. Alternatively, the first orientation corresponding to the master virtual object is east when the first attack operation is received, and the second orientation corresponding to the master virtual object is south when the second attack operation is received. To be specific, the orientation corresponding to the master virtual object may change or remain unchanged when the first attack operation and the second attack operation are received.

The foregoing descriptions are only illustrative examples. This is not limited in the embodiments of this disclosure.

Operation 441: Display, in a case that a first virtual object is within a first attack range, the master virtual object attacking the first virtual object in response to the second attack operation.

Schematically, upon receiving the second attack operation, if it is determined that the first virtual object is located within the first attack range, considering that the player successively performs the first attack operation and the second attack operation and is highly likely to continue attacking the previously attacked first virtual object, the first virtual object may first be taken as a candidate object attackable by the second attack operation, and then a target virtual object to be attacked in the second attack operation is determined from at least one first virtual object.

To be specific, the first virtual object is an attacked target virtual object, and the target virtual object is a battle virtual object in at least one first virtual object.

In some embodiments, all first virtual objects attacked based on the first attack operation are taken as target virtual objects to be attacked in the second attack operation.

Schematically, there are five battle virtual objects as the first virtual objects attacked based on the first attack operation, and three battle virtual objects, among the five battle virtual objects, within the first attack range are all taken as target virtual objects.

In some embodiments, the first virtual objects attacked based on the first attack operation are screened, and the first virtual objects that meet a preset screening rule are taken as target virtual objects to be attacked in the second attack operation.

Schematically, there are five battle virtual objects as the first virtual objects attacked based on the first attack operation, where three battle virtual objects among the five battle virtual objects are within the first attack range. The three battle virtual objects are screened according to a preset screening rule to determine at least one first virtual object as the target virtual object. For example, the preset screening rule is to take a battle virtual object with a minimum virtual health point as a to-be-attacked virtual object. Then, the first virtual object with a minimum virtual health point among the three battle virtual objects is taken as a to-be-attacked target virtual object. In some embodiments, the preset screening rule may be set based on various manners such as a virtual mana point, a spatial distance, or an absolute virtual health point. This is not limited herein.

The first virtual object is a battle virtual object attacked by the first attack operation prior to the second attack operation. If the first attack range corresponding to the second attack operation includes the first virtual object, the first virtual object targeted by the previous first attack operation may be taken as an object to be continuously attacked during the process of selecting the battle virtual object to be automatically attacked based on the second attack operation, thereby simplifying player operations, satisfying the player's wish to inflict a continuous and sustained attack damage on the first virtual object, improving game smoothness and playability, reducing the interaction burden of the player in complex virtual battles, improving operation efficiency, lowering the risk of attack errors, enhancing game policy and coherence, and making virtual battles smoother and more interesting.

In an embodiment, in a case that the first virtual object is within the first attack range, the master virtual object attacking a first virtual object with a minimum virtual health value is displayed.

The first virtual object with the minimum virtual health value is the target virtual object.

Schematically, in a case that the first virtual object is within the first attack range, the preset screening rule is, for example, implemented as selecting the battle virtual object with the minimum virtual health value as the to-be-attacked virtual object, and the first virtual object with the minimum virtual health value is taken as the to-be-attacked target virtual object, thereby displaying the master virtual object attacking the first virtual object with the minimum virtual health value.

By comprehensively considering the first virtual object targeted by the previous first attack operation and a virtual health value, and selectively determining the target virtual object to be automatically attacked from those within the first attack range, a first virtual object with a low health value that is suitable for priority attack and elimination may be intelligently evaluated. This not only makes an attack target (a battle virtual object to be attacked) more in line with the player's psychological expectation, but also facilitates the implementation of more favorable tactical operations to gain an advantage in the virtual battle. In addition, the automatic determination of the minimum health value frees the player from manual target selection, maintains game smoothness even in fast-paced virtual battles, realizes an intelligent combat process, and improves human-computer interaction efficiency.

In an embodiment, in a case that the first virtual object is within the first attack range, the master virtual object attacking a first virtual object closest to the master virtual object is displayed.

The first virtual object with the shortest object distance is the target virtual object.

Schematically, in a case that the first virtual object is within the first attack range, the preset screening rule is, for example, implemented as selecting the battle virtual object closest to the master virtual object as the to-be-attacked virtual object, and the first virtual object closest to the master virtual object is taken as the to-be-attacked target virtual object, thereby displaying the master virtual object attacking the first virtual object closest to the master virtual object.

By comprehensively considering the first virtual object targeted by the previous first attack operation and an object distance factor, and selectively determining the first virtual object closest to the master virtual object from those within the first attack range as the attacked target virtual object, the first virtual object that is controlled by the master virtual object and thus preferentially eliminated may be intelligently evaluated. This makes the attack object more in line with the player's psychological expectation, ensures faster execution of the attack process, and improves battle efficiency. In addition, this process also helps to better defend against virtual attacks from the battle virtual object with the shortest distance, achieves effective response to urgent threats, helps maintain the continuous combat capability of the master virtual object, ensures suitability and efficiency of battle policies, and improves human-computer interaction efficiency.

Operation 442: Display, in a case that a first virtual object corresponding to the first attack operation does not exist within a first attack range, the master virtual object attacking a target virtual object in response to the second attack operation.

The target virtual object is a battle virtual object different from the first virtual object in the at least two battle virtual objects.

Schematically, if the first virtual object targeted by the first attack operation does not exist within the first attack range, a to-be-attacked battle virtual object needs to be determined from the first attack range as the target virtual object.

In an embodiment, the master virtual object attacking a battle virtual object with a minimum virtual health value within the first attack range is displayed.

The battle virtual object with the minimum virtual health value is the target virtual object.

Schematically, the preset screening rule is, for example, implemented as selecting the battle virtual object with the minimum virtual health value as the to-be-attacked virtual object, and the battle virtual object with the minimum virtual health value within the first attack range is taken as the to-be-attacked target virtual object, thereby displaying the master virtual object attacking the target virtual object.

In an embodiment, the master virtual object attacking a battle virtual object closest to the master virtual object within the first attack range is displayed.

The battle virtual object with the shortest object distance is the target virtual object.

Schematically, the preset screening rule is, for example, implemented as selecting the battle virtual object closest to the master virtual object as the to-be-attacked virtual object, and the battle virtual object closest to the master virtual object is taken as the to-be-attacked target virtual object.

In an embodiment, in response to the second attack operation, in a case that no battle virtual object exists within the first attack range, the master virtual object performing an attack effect toward the first attack range is displayed.

Schematically, if no battle virtual object exists within the first attack range corresponding to the second attack operation, effective attack on a battle virtual object cannot be performed based on the second attack operation. To avoid invalid execution of the attack operation, the attack effect corresponding to the second attack operation may be presented on the screen of the terminal. To be specific, the master virtual object performing an attack effect toward the first attack range is displayed.

In some embodiments, the attack effect performed by the master virtual object toward the first attack range has a particular attack effect. When the attack effect reaches the first attack range and a battle virtual object exists within the first attack range at the current time, a virtual damage may still be inflicted on the battle virtual object.

In some embodiments, the attack effect performed by the master virtual object toward the first attack range has a continuous attack effect of a preset duration. When the attack effect reaches the first attack range and a battle virtual object enters the first attack range within the preset duration, a virtual damage may still be inflicted on the battle virtual object.

In some embodiments, the attack effect performed by the master virtual object toward the first attack range has a continuous attack effect of a preset duration and a hiding effect of a preset duration. After the attack effect reaches the first attack range, the attack effect is hidden, and the hiding effect and the attack effect last for the preset duration. If a battle virtual object enters the first attack range within the preset duration, a virtual damage may still be inflicted on the battle virtual object.

The foregoing content briefly introduces implementations when the first virtual object does not exist within the first attack range. If the first virtual object targeted by the first attack operation prior to the second attack operation does not exist within the first attack range, to avoid invalid attacks of the second attack operation as much as possible, a battle virtual object other than the first virtual object and capable of being attacked is searched from the first attack range corresponding to the second attack operation as the target virtual object. In this process, the battle virtual object with the minimum health value or the shortest distance may be attacked, so as to improve attack efficiency as much as possible while avoiding invalid attacks, thereby helping achieve tactical coherence and adaptability of combat policies, avoiding waste of attack resources, and also helping ensure the gaming experience of the player. In addition, even if no battle virtual object exists within the first attack range, the master virtual object performing an attack effect toward the first attack range may be displayed, thereby enriching the screen display effect and helping maintain the gaming experience of the player.

In an embodiment, in response to the second attack operation being received within a preset time period following the first attack operation, the master virtual object attacking a target virtual object in the at least two battle virtual objects is displayed based on a positional relationship between the first virtual object and the first attack range.

The second attack operation received within the preset time period and the first attack operation are combo attack operations. Schematically, when at least two attack operations are received consecutively within the preset time period, the at least two attack operations may be regarded as combo attack operations, so that a battle virtual object to be automatically attacked currently may be analyzed jointly by means of the first virtual object hit and/or to be attacked by the previous attack operation (e.g., the first attack operation) and the second attack range corresponding to a current attack operation (e.g., the second attack operation).

The preset time period is used as a condition for determining the positional relationship between the first virtual object and the first attack range. If a plurality of attack operations are received consecutively within the preset time period, the plurality of attack operations may be regarded as combo attacks, so as to ensure that the attack operations are closely connected in time, avoid gaps or invalidity between attack operations, and enable continuous and smooth implementation of virtual attacks. This process can effectively exert continuous pressure on battle virtual objects, and may make consecutive attack operations more threatening than separate attack operations by triggering additional damage bonuses, special effects, or combo damage, and better reflect the determination of the player to attack the first virtual object, thereby making the process of determining the positional relationship between the first virtual object and the first attack range more suitable, realizing intelligent object selection, greatly improving attack efficiency and tactical depth, avoiding invalid attacks, reducing operation burden, adding combo effects, and optimizing the overall combat experience and tactical execution.

The foregoing descriptions are only illustrative examples. This is not limited in the embodiments of this disclosure.

In summary, in combination with a first virtual object targeted by a previous first attack operation of a player, a target virtual object to be attacked may be automatically determined from a plurality of battle virtual objects in a manner more in line with player expectations, thereby improving the accuracy of selecting the target virtual object, saving computing resources during a game, helping ensure the precision and fluency of automatic object selection, and enhancing human-computer interaction efficiency during the game while improving the gaming experience of the player.

In the embodiments of this disclosure, the relationship between the first attack operation and the second attack operation is described with reference to the accompanying drawings. The second attack operation and the first attack operation are implemented as a combo attack. If the first virtual object is within the first attack range, the first virtual object may be taken as the target virtual object automatically attacked by the second attack operation. If the first virtual object is not within the first attack range, the target virtual object automatically attacked by the second attack operation is selected from battle virtual objects other than the first virtual object. By taking the first virtual object targeted by the first attack operation as a factor to be considered in the attack based on the second attack operation, the target virtual object automatically determined to be attacked is more in line with the selection expectation of the player, thereby giving full play to the advantages of combo attacks, and improving human-computer interaction efficiency.

In an embodiment, each attack operation corresponds to a marking range and an attack range. When determining the target virtual object upon receiving the current second attack operation, the marking range corresponding to the first attack operation is also considered in addition to the first virtual object targeted by the previously received first attack operation. To be specific, a target virtual object to be attacked by the master virtual object is determined jointly based on the marking range and the first virtual object. As shown in FIG. 9, operation 340 shown in FIG. 3 may be further implemented as the following operation 910 or operation 920.

Operation 910: Display, in a case that a first virtual object is not within a first attack range and the first attack range includes a second virtual object within a marking range, a master virtual object attacking the second virtual object in response to the second attack operation.

The target virtual object includes the second virtual object.

Schematically, upon receiving the second attack operation, a relative positional relationship between the first virtual object and the first attack range is determined. For example, the first virtual object is within the first attack range, or the first virtual object is not within the first attack range.

In some embodiments, the first virtual object, as the battle virtual object targeted by the first attack operation, may have been successfully attacked based on the first attack operation upon receiving the second attack operation, or may not have been successfully attacked based on the first attack operation upon receiving the second attack operation. Differences in whether the first virtual object has been successfully attacked based on the first attack operation result in differences in the determination of the relative positional relationship between the first virtual object and the first attack range.

In some embodiments, in response to the second attack operation, if the first virtual object successfully attacked based on the first attack operation is within the first attack range, the master virtual object attacking the first virtual object is displayed as the target virtual object.

In some embodiments, in response to the second attack operation, if the first virtual object not successfully attacked based on the first attack operation is within the first attack range, the master virtual object attacking the target virtual object is displayed. The target virtual object may be implemented as the first virtual object or another battle virtual object other than the first virtual object.

In some embodiments, in response to the second attack operation, if the first virtual object successfully attacked based on the first attack operation is not within the first attack range, the master virtual object attacking the target virtual object is displayed. The target virtual object is another battle virtual object other than the first virtual object.

In some embodiments, in response to the second attack operation, if the first virtual object not successfully attacked based on the first attack operation is not within the first attack range, the master virtual object attacking the target virtual object is displayed. The target virtual object is another battle virtual object other than the first virtual object.

The first attack operation corresponds to a second attack range and a marking range, and the second attack range is a sub-region range within the marking range.

Schematically, similar to the first attack range corresponding to the second attack operation, the first attack operation corresponds to the second attack range. The second attack range is configured for representing a region range where a virtual damage is inflicted based on the first attack operation.

Schematically, in addition to the second attack range, the first attack operation also corresponds to a marking range. The second attack range is a sub-region range of the marking range. To be specific, the marking range includes the second attack range.

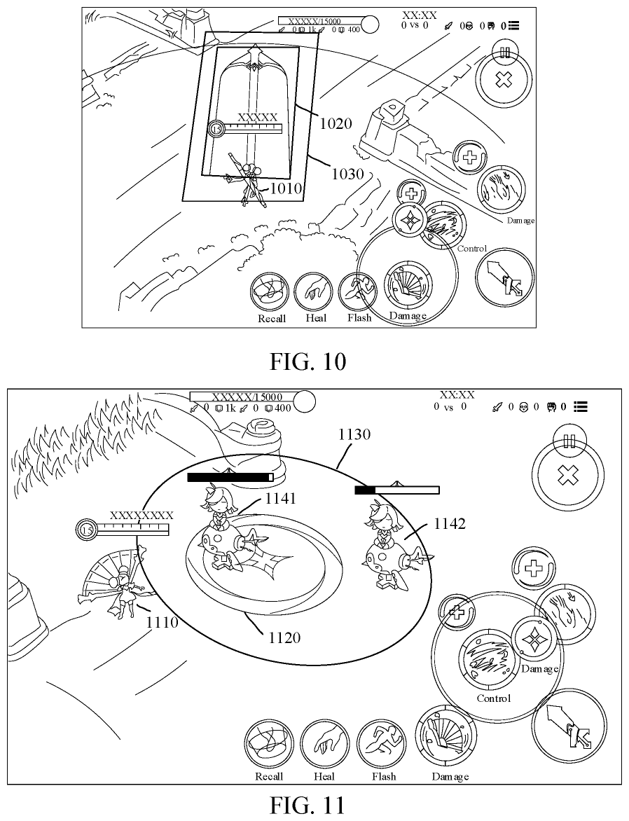

FIG. 10 shows a schematic diagram of an interface corresponding to a first attack operation. A virtual scene includes a master virtual object 1010. A second attack range 1020 corresponding to a first attack operation launched by the master virtual object 1010 is implemented as a rectangular region. The first attack operation also corresponds to a marking range 1030 implemented as a larger rectangular region. The second attack range 1020 is included within the marking range 1030 and is a sub-region range of the marking range 1030.

FIG. 11 shows a schematic diagram of another interface corresponding to a first attack operation. A virtual scene includes a master virtual object 1110. A second attack range 1120 corresponding to a first attack operation launched by the master virtual object 1110 is implemented as a circular region. The first attack operation also corresponds to a marking range 1130 implemented as a larger circular region. The second attack range 1120 is included within the marking range 1130 and is a sub-region range of the marking range 1130.

Schematically, the second attack range corresponding to the first attack operation may be displayed on an interface for a player to view flexibly. The marking range corresponding to the first attack operation may be displayed on the interface or in a hidden state, i.e., not displayed on the interface. The display situations of the marking range and the second attack range are not limited herein.

In some embodiments, in response to a second attack operation, if a first virtual object is not within a first attack range, it is determined whether the first attack range includes a second virtual object within the marking range.

The second virtual object is a battle virtual object not the first virtual object within the marking range.

As shown in FIG. 11, battle virtual objects participating in a virtual battle together with the master virtual object 1110 include a battle virtual object 1141 and a battle virtual object 1142. The first virtual object targeted by the first attack operation launched by the master virtual object 1110 is the battle virtual object 1141, and the battle virtual object 1142 not the first virtual object but within the marking range 1130 is the second virtual object.

In response to the second attack operation, if the first virtual object 1141 is not within the first attack range corresponding to the second attack operation (the first attack operation is shown in FIG. 11, and the second attack operation is not shown), it is determined whether the first attack range includes the second virtual object within the marking range.

In some embodiments, if the first attack range includes the second virtual object within the marking range, the second virtual object is automatically determined as the target virtual object targeted by the second attack operation, and the master virtual object is controlled to attack the second virtual object based on the second attack operation, thereby displaying the master virtual object attacking the second virtual object.

As shown in FIG. 11, if the first attack range corresponding to the second attack operation includes the second virtual object (i.e., the battle virtual object 1142) within the marking range corresponding to the first attack operation, the battle virtual object 1142 is taken as the target virtual object targeted by the second attack operation based on the second attack operation, and the master virtual object 1110 attacking the battle virtual object 1142 is displayed.

In an embodiment, a first object identifier is added to the battle virtual object within the marking range based on the first attack operation.

Schematically, to facilitate more accurate determination of the target virtual object in combination with the first attack operation upon receiving the second attack operation, a first object identifier may be added to the battle virtual object within the marking range after receiving the first attack operation. The first object identifier may be implemented as visible identification content on the interface or invisible identification content on the interface (i.e., the first object identifier is hidden, and the first object identifier is marked by means of background marking).

In an embodiment, in a case that the first virtual object is not within the first attack range, the battle virtual object marked with the first object identifier within the first attack range is determined as the second virtual object.

Schematically, if the first virtual object is not within the first attack range, battle virtual objects within the first attack range corresponding to the second attack operation are searched to determine whether there is a battle virtual object marked with the first object identifier. If yes, the battle virtual object marked with the first object identifier within the first attack range is taken as the second virtual object, so that the master virtual object is controlled to attack the battle virtual object marked with the first object identifier based on the second attack operation.

In an embodiment, the master virtual object attacking the second virtual object is displayed.

Schematically, the master virtual object is controlled to attack the second virtual object marked with the first object identifier based on the second attack operation, thereby displaying the master virtual object attacking the second virtual object, where the second virtual object is taken as the target virtual object.

The foregoing content describes adding a first object identifier to the battle virtual object within the marking range to facilitate quick content search of the battle virtual object. The first object identifier may clearly distinguish the battle virtual object within the marking range from the battle virtual object not within the marking range, thereby providing assistance for an object search process. This allows efficient priority search of the second virtual object with the first object identifier when the first virtual object is not within the first attack range, reducing the computational load of matching analysis, helping ensure the continuity and effectiveness of virtual attacks, flexibly determining the target virtual object to be attacked based on the positions of battle virtual objects, improving virtual battle efficiency, and enhancing game immersion and human-computer interaction experience.

In an embodiment, in response to the first attack operation inflicting an attack damage to a fourth virtual object in the first virtual object, a second object identifier is added to the fourth virtual object within the second attack range.

Schematically, the first attack operation targets the first virtual object within the second attack range. However, when the second attack operation is received, the first virtual object may have already received a virtual damage based on the first attack operation or may not have received a virtual damage. Therefore, when determining the target virtual object based on the second attack operation, whether the first attack operation has inflicted damage on the first virtual object may be considered first.

In some embodiments, if the first attack operation has inflicted an attack damage on the first virtual object, the first virtual object that has received the attack damage may be referred to as the fourth virtual object, and a second object identifier is added to the fourth virtual object. To be specific, a second object identifier is added to the first virtual object within the second attack range that has received the attack damage from the first attack operation.

Schematically, the second object identifier may be implemented as visible identification content on the interface or invisible identification content on the interface (i.e., the second object identifier is hidden, and the second object identifier is marked by means of background marking).

A priority of the second object identifier is higher than that of the first object identifier.

Schematically, considering that the fourth virtual object attacked based on the first attack operation is more in line with the attack expectation of the player, the priority of the second object identifier may be set to be higher than that of the first object identifier. To be specific, when a first attack region corresponding to the second attack operation contains both the fourth virtual object marked with the second object identifier (i.e., the first virtual object that has received an attack damage) and the battle virtual object marked with the first object identifier, the fourth virtual object marked with the second object identifier is preferentially taken as a target virtual object to be attacked by the second attack operation. If the first attack region corresponding to the second attack operation does not contain the first virtual object marked with the second object identifier but only contains the battle virtual object marked with the first object identifier, the battle virtual object marked with the first object identifier is taken as the target virtual object to be attacked by the second attack operation.

In an embodiment, in response to the second attack operation, the fourth virtual object marked with the second object identifier within the first attack range is determined.

Schematically, if the priority of the second object identifier is higher than that of the first object identifier, it is first determined, under the second attack operation, whether the first attack range corresponding to the second attack operation contains the fourth virtual object marked with the second object identifier. If yes, the fourth virtual object marked with the second object identifier is taken as the target virtual object. If no, it may be determined whether the first attack range contains the battle virtual object marked with the first object identifier.

In some embodiments, when a plurality of fourth virtual objects marked with the second object identifier exist within the first attack range, the plurality of fourth virtual objects marked with the second object identifier are screened to determine one fourth virtual object as the target virtual object.

Schematically, when a plurality of fourth virtual objects marked with the second object identifier exist within the first attack range, a fourth virtual object with a minimum virtual health value among the plurality of fourth virtual objects is taken as the target virtual object, or a fourth virtual object closest to the master virtual object among the plurality of fourth virtual objects is taken as the target virtual object.

In an embodiment, the master virtual object attacking the fourth virtual object is displayed.

Schematically, after the fourth virtual object marked with the second object identifier within the first attack range is taken as the target virtual object, the master virtual object attacking the target virtual object may be displayed. To be specific, based on the second attack operation, the master virtual object attacking the first virtual object that has already suffered damage from the first attack operation is displayed.

The foregoing content takes into account the virtual attack damage inflicted on the battle virtual object by the first attack operation prior to the second attack operation. A second object identifier is added to the fourth virtual object in the at least one first virtual object that has received a virtual attack damage from the first attack operation. In a case that the priority of the second object identifier is higher than that of the first object identifier, the fourth virtual object may be efficiently searched within the first attack range corresponding to the second attack operation based on the second object identifier, improving object search efficiency. In addition, the fourth virtual object is taken as the battle virtual object to be continuously attacked by the second attack operation, so that the attack process is more in line with the psychological expectation of the player, thereby improving attack coherence, eliminating the fourth virtual object as quickly as possible, enhancing virtual battle efficiency, and helping avoid the problem of low resource utilization caused by scattered attacks. Flexible attack policies improve resource utilization efficiency, overall combat efficiency, and human-computer interaction efficiency.

Operation 920: Display, in a case that a first virtual object is not within a first attack range and the first attack range does not include a second virtual object within a marking range, a master virtual object attacking a third virtual object in response to the second attack operation.

The target virtual object includes the third virtual object.

Schematically, upon receiving the second attack operation, a relative positional relationship between the first virtual object and the first attack range is determined. For example, the first virtual object is within the first attack range, or the first virtual object is not within the first attack range.

If the first virtual object is not within the first attack range corresponding to the second attack operation, it is determined whether a second virtual object within the marking range exists within the first attack range, where the second virtual object is a battle virtual object that is within the marking range but is not the first virtual object.

In some embodiments, when no second virtual object within the marking range exists within the first attack range, a third virtual object is selected from the first attack range as the target virtual object, thereby displaying the master virtual object attacking the third virtual object.

The third virtual object is within the first attack range but not within the marking range, and is not the first virtual object.

In some embodiments, the battle virtual object that is within the marking range but is not the first virtual object is marked with the first object identifier. When determining whether a second virtual object within the marking range exists within the first attack range, it is determined whether the battle virtual object marked with the first object identifier exists within the first attack range. If no battle virtual object marked with the first object identifier exists within the first attack range, it means that no second virtual object exists within the first attack range, and the third virtual object is then selected from the first attack range as the target virtual object.

In some embodiments, the third virtual object is a battle virtual object with a minimum virtual health value within the first attack range under the condition that neither the first virtual object nor the second virtual object exists within the first attack range. Alternatively, the third virtual object is a battle virtual object closest to the master virtual object within the first attack range under the condition that neither the first virtual object nor the second virtual object exists within the first attack range.

The foregoing descriptions are only illustrative examples. This is not limited in the embodiments of this disclosure.

In summary, in combination with a first virtual object targeted by a previous first attack operation of a player, a target virtual object to be attacked may be automatically determined from a plurality of battle virtual objects in a manner more in line with a condition expected by the player, thereby improving the accuracy of selecting the target virtual object, saving computing resources during a game, helping ensure the precision and fluency of automatic object selection, and enhancing human-computer interaction efficiency during the game while improving the gaming experience of the player.

In the embodiments of this disclosure, content is introduced in which a marking range is employed to determine a target virtual object. The marking range is a range corresponding to the first attack operation, and the second attack range corresponding to the first attack operation is a sub-region range of the marking range. In this way, a greater number of battle virtual objects may serve as battle virtual objects considered for determining the target virtual object by means of the marking range. By combining the marking range and the already attacked first virtual object, a target virtual object that better matches the attack expectation of the player can be searched in a case that the first attack operation and the second attack operation are received consecutively, thereby improving the accuracy of automatically determining the target virtual object and enhancing human-computer interaction efficiency.

The embodiments of this disclosure also describe a virtual attack situation in which the first attack range includes neither the first virtual object nor the second virtual object within the marking range. It is preferentially determined whether the first virtual object and the second virtual object within the marking range exist within the first attack range. If no, a virtual attack is launched against a third virtual object within the first attack range to avoid invalid execution of the second attack operation. This process ensures that primary attack objects (the first virtual object and the second virtual object) are handled preferentially to improve overall attack efficiency, while avoiding resource waste so that each virtual attack produces an actual attack effect as much as possible, thereby better achieving suitable allocation of attack resources, enhancing adaptability and policy adjustment efficiency in virtual battles, helping ensure the user experience of the player, and improving human-computer interaction efficiency.

In an embodiment, the method for controlling objects in a virtual scene may be applied to an MOBA game, and may alternatively be referred to as “Target Locking Method for Operating Virtual Hero to Implement Skill Combos in MOBA Game”, where the virtual hero is the master virtual object controlled by the player. A skill is a means operated by the player in a virtual application to interact with other battle virtual objects. Target locking refers to a method in which, after a special input by the player, the game determines and attacks the battle virtual object based on preset logical rules.

In some embodiments, some basic operation semantics in the MOBA game are first described.

Light-tap operation is a common operation manner in mobile games, referring to an action in which a player presses vertically on a screen of a mobile phone without performing sliding, dragging, or other operations on the screen of the mobile phone, and then lifts the finger perpendicularly to the screen of the mobile phone.

Drag operation is another common operation manner in mobile games, referring to an action in which a player presses on a screen of a mobile phone, moves the finger parallel to the screen of the mobile phone to slide or drag for a particular distance, and then lifts the finger.

FIG. 5 is a schematic diagram of an interface of an MOBA mobile game. In the MOBA mobile game, a virtual object (e.g., a master virtual object 510) is typically controlled using a dual-joystick mode: the left hand controls movement of the virtual object in a virtual scene, and the right hand controls the virtual object to perform skill release. Therefore, the light-tap operation and the drag operation are two common skill control manners. The light-tap operation is often used to release skills that do not require selection of a battle virtual object, a position, or a direction. For example, skill effects such as increasing an attack speed of the virtual object or increasing a health point of the virtual object are usually implemented via the light-tap operation.

In current MOBA mobile games, to lower the operation threshold and enable meaningful player input, skills that require selection of a battle virtual object, a position, or a direction are configured to still take effect when triggered by the light-tap operation. The battle virtual object specifically attacked by such a skill under the light-tap operation may be determined by a set of preset “target locking rules”.

To be specific, if a skill that does not require selection of a battle virtual object, a position, or a direction is referred to as a light-tap skill, the light-tap skill may be implemented via a light-tap operation or a non-light-tap operation, and the light-tap operation and the non-light-tap operation applied to the light-tap skill produce identical effects, namely releasing skills without selecting a battle virtual object, a position, or a direction. If a skill that requires selection of a battle virtual object, a position, or a direction is referred to as a non-light-tap skill, the non-light-tap skill may be implemented via a light-tap operation or a non-light-tap operation. The non-light-tap operation on the non-light-tap skill means performing a targeted attack based on a battle virtual object, a position, or a direction selected by the player (i.e., the first virtual object is a battle virtual object manually selected by the player). The light-tap operation on the non-light-tap skill means that a terminal automatically selects and attacks a battle virtual object that the player is most likely intended to attack (i.e., the first virtual object is a battle virtual object automatically determined by the terminal based on “target locking rules”).

Therefore, if skills are simply divided into light-tap skills and non-light-tap skills and operations received by the system are divided into light-tap operations and non-light-tap operations, the operation implementation situations are divided into the following three types: the player performs a light-tap operation on a light-tap skill (since performing a non-light-tap operation on a light-tap skill produces the same system result as a light-tap operation), the player performs a non-light-tap operation on a non-light-tap skill, and the player performs a light-tap operation on a non-light-tap skill.

In related technology, basic target locking rules for MOBA games apply to individual skills. To be specific, if a non-light-tap skill is triggered by a light-tap operation, the current target locking rules control the master virtual object to automatically select and attack a “battle virtual object with a minimum absolute health point (health value)”, or control the master virtual object to automatically select and attack a “battle virtual object with a minimum relative health point (health percentage)”, or control the master virtual object to automatically select and attack a “battle virtual object with the shortest distance”.

However, MOBA games involve a demand for skill combos, namely a demand for the player to input a plurality of skills within a short period of time. Different skills have different casting manners. Taking the simplest case where the player inputs two skills within a short period of time as an example, the following four arrangements may exist.
(1) The first skill is a light-tap skill, and the second skill is a light-tap skill. The two light-tap skills may be the same or different. A trigger operation for the light-tap skill is implemented as a light-tap operation (since a non-light-tap operation achieves the same effect).
(2) The first skill is a light-tap skill, and the second skill is a non-light-tap skill. The two skills are different. A trigger operation for the light-tap skill is implemented as a light-tap operation (since a non-light-tap operation achieves the same effect), and a trigger operation for the non-light-tap skill is implemented as a light-tap operation (target locking rules are required under the light-tap operation, and target locking rules are not required under the non-light-tap operation).
(3) The first skill is a non-light-tap skill, and the second skill is a light-tap skill. The two skills are different. A trigger operation for the non-light-tap skill may be implemented as a light-tap operation or a non-light-tap operation. A trigger operation for the light-tap skill is implemented as a light-tap operation.
(4) The first skill is a non-light-tap skill, and the second skill is a non-light-tap skill. The two skills may be the same or different. A trigger operation for the first non-light-tap skill may be implemented as a light-tap operation or a non-light-tap operation. A trigger operation for the second non-light-tap skill is implemented as a light-tap operation.

In MOBA games, the player has a demand for combo attacks. For example, the player has a demand to cast two skills onto the same battle virtual object simultaneously. Taking case 4 among the foregoing four cases as an example, the first skill is a non-light-tap skill, and the second skill is a non-light-tap skill. If a battle virtual object to be attacked is automatically determined only by using the foregoing target locking rules [a battle virtual object with a minimum absolute health point (health value), controlling the master virtual object to automatically select and attack a battle virtual object with a minimum relative health point (health percentage)], the demand of the player may not be satisfied.

As shown in FIG. 6, if the player performs a non-light-tap operation for a non-light-tap skill during a first attack (first attack operation), the master virtual object can be controlled to attack a battle virtual object 621 (i.e., the first virtual object) in a targeted manner. Then, if the player performs a light-tap operation for a non-light-tap skill (which may be the same or different) during a second attack (second attack operation), a battle virtual object 622 is automatically determined as a battle virtual object to be attacked by the second attack operation based on the target locking rule adopted in the related art being a battle virtual object with a minimum absolute health point 630 (health value). Thus, in a case that the first attack operation and the second attack operation are implemented as combo operations, the battle virtual object more in line with the attack expectation of the player cannot be automatically determined for the player through the foregoing target locking rule, thereby affecting virtual battle efficiency.

In an embodiment, a marker screening-based target locking rule may be adopted. To be specific, when a skill is released for the first time (i.e., after receiving the first attack operation), a corresponding object marker is added to the hit battle virtual object. During the second light-tap target locking (i.e., after receiving the second attack operation for automatically determining a battle virtual object), all battle virtual objects are divided into two categories: “marked battle virtual objects” and “unmarked battle virtual objects”.

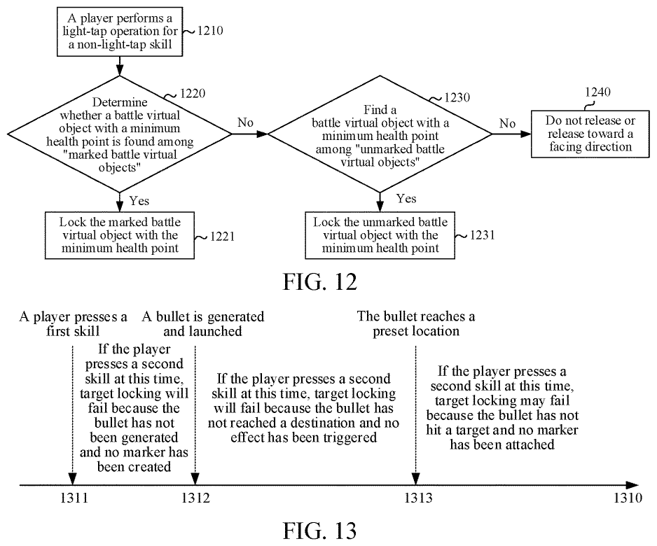

FIG. 12 shows a determining flowchart of determining a target virtual object based on a second attack operation.

Operation 1210: A player performs a light-tap operation for a non-light-tap skill.

Schematically, within a preset time period, a second attack operation is received upon receiving at least one first attack operation, where the second attack operation is an attack operation for automatically determining a to-be-attacked battle virtual object, for example, implemented as an operation of performing a light-tap operation for a non-light-tap skill, and the non-light-tap skill is capable of achieving a virtual attack effect.

Operation 1220: Determine whether a battle virtual object with a minimum health point is found among “marked battle virtual objects”.

Schematically, a target locking rule is, for example, to search for a battle virtual object with a minimum health point. Based on a first attack range corresponding to the second attack operation, “marked battle virtual objects” are first searched within the first attack range. If found, the following operation 1221 is performed. If not found, the following operation 1230 is found.

Operation 1221: Lock the marked battle virtual object with the minimum health point.

Schematically, if marked battle virtual objects are found within the first attack range, the battle virtual object with the minimum health point in at least one battle virtual object is taken as a target virtual object targeted by the second attack operation.

Operation 1230: Find a battle virtual object with a minimum health point among “unmarked battle virtual objects”.

Schematically, if no “marked battle virtual objects” are found within the first attack range, the battle virtual object with the minimum health point is searched from at least one unmarked battle virtual object within the first attack range. If found, the following operation 1231 is performed. If not found, the following operation 1240 is found.

Operation 1231: Lock the unmarked battle virtual object with the minimum health point.

Schematically, if an unmarked battle virtual object with the minimum health point is found within the first attack range, the battle virtual object is taken as a target virtual object targeted by the second attack operation.

Operation 1240: Do not release or release toward a facing direction.

Schematically, if no battle virtual object with the minimum health point can be found within the first attack range, the skill may not be released, or the skill may be released toward a facing direction of a master virtual object.

However, the foregoing approaches do not take into account situations such as “the skill fails to hit a battle virtual object”, “target locking during the skill validity period”, or “skill input buffering”, resulting in situations where a player still cannot attack a desired battle virtual object.

For example, when a skill fails to hit a battle virtual object, a corresponding object marker cannot be attached to a first virtual object intended to be attacked by the player, invalidating the foregoing target locking logic.

Alternatively, MOBA games involve numerous “bullet”-like skills that require a flight duration from launch to effect. During this flight period, if the player demands a combo (i.e., a second attack operation is received before the first attack operation hits the first virtual object), no object marker is attached since the skill has not successfully attacked, thus invalidating the target locking logic.

Alternatively, MOBA games adopt a combo buffering mechanism together with skill wind-ups. After the player releases a skill, if the player demands a combo during the wind-up period before the skill takes effect, tapping the skill (second attack operation) will still result in no object marker being attached to the first virtual object, as the skill corresponding to the first attack operation has not taken effect, thus invalidating the target locking logic.

As shown in FIG. 13, a schematic diagram of an implementation process of a bullet skill is illustrated. The bullet skill refers to a skill for which the release process is analogized to the firing of a bullet, so as to provide a quantitative description of the skill release process. On a timeline 1310 from skill release to termination, the reason for failing to accurately and automatically determine a target virtual object is explained, as an object identifier is only marked on a first virtual object successfully attacked by a first attack operation.

At time 1311 on the timeline 1310, a player presses a first skill, meaning that a terminal receives a first attack operation. At time 1312, a bullet is generated and launched. For example, the skill starts releasing from a master virtual object. At time 1313, the bullet reaches a preset location. For example, the skill arrives at the first virtual object targeted by the first attack operation.

If the player presses a second skill between time 1311 and time 1312, to be specific, the terminal receives the second attack operation between time 1311 and time 1312, target locking will fail as no bullet is generated and thus no identifier is generated. If the player presses the second skill between time 1312 and time 1313, to be specific, the terminal receives the second attack operation between time 1312 and time 1313, target locking will fail as the bullet has not reached the preset location and produced an effect. If the player presses the second skill after time 1313, to be specific, the terminal receives the second attack operation after time 1313, target locking may still fail as the bullet may have missed the first virtual object and the first virtual object is thus unmarked.

To be specific, in the practical application based on FIG. 12 and FIG. 13, the player perceives that the skill attacks an unintended battle virtual object, or even that the skill behaves in a reversed manner.

In an embodiment, improvements are made to the processes shown in FIG. 12 and FIG. 13, such that object markers are no longer limited to an actual attack effect of the skill. To be specific, markers are not attached based on the actual effect of the skill and are not strongly correlated with the actual effect. Instead, all battle virtual objects within the attention range of the player are marked (with the first object identifier) when the skill logic takes effect. This marking behavior is independent of the game logic perceived by the player and may be implemented as an invisible, unknown background behavior.

In some embodiments, the process of marking battle virtual objects depends on the skill type. The basic logic is: when the player uses a skill of a directional skill attack type, a battle virtual object intended to be attacked by the player is always along or around the selected direction. Therefore, a marking range larger than the attack range and oriented toward this direction may be used to assist in locating the battle virtual object.

As shown in FIG. 10, a second attack range 1020 corresponding to a first attack operation is included within a marking range 1030 and is a sub-region range of the marking range 1030. Alternatively, as shown in FIG. 11, a second attack range 1120 corresponding to a first attack operation is included within a marking range 1130 and is a sub-region range of the marking range 1130.

By defining the marking range, it is ensured that when a player locks onto a target via a tap operation (automatically determining a battle virtual object), the tap operation can still attack the intended battle virtual object even if the skill has not actually hit an enemy in a real game scene.

In some embodiments, the method of determining a target virtual object corresponding to a second attack operation via a marking range may expand the scope of “intended battle virtual object”. When the skill actually takes effect and produces an attack effect to the desired first virtual object, the tap operation may hit an unintended enemy since the marking range is larger than the second attack range corresponding to the first attack operation.

As shown in FIG. 11, when a non-tap skill is used to attack a battle virtual object 1141 during the first attack operation, a battle virtual object 1142 is also marked since the marking range 1130 is larger than the second attack range 1120. When the second attack operation triggers the non-tap skill via a tap operation, it may attack the battle virtual object 1142 instead of the battle virtual object 1141.

In some embodiments, to solve the foregoing problem, a brand-new three-level structure may be adopted to implement a determination process based on the expanded marking range.

When the first attack operation for the skill actually hits the first virtual object, a normal identifier (i.e., the first object identifier) is attached to the battle virtual object within the marking range, and an advanced marker (i.e., the second object identifier) is attached to the first virtual object actually hit by the skill. The advanced marker overrides a normal marker (i.e., an advanced identifier has higher priority than the normal identifier).

Therefore, when receiving the second attack operation and determining the to-be-attacked battle virtual object, battle virtual objects within the first attack range corresponding to the second attack operation may be divided into: battle virtual objects with advanced markers, battle virtual objects with normal markers, and battle virtual objects without any markers.

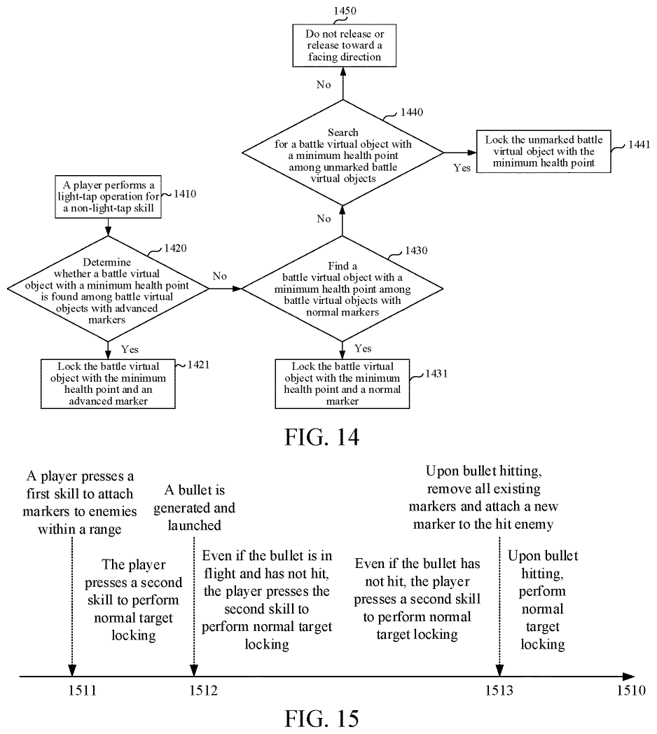

Schematically, FIG. 14 shows a determining flowchart of determining a target virtual object based on a second attack operation in a marking range.

Operation 1410: A player performs a light-tap operation for a non-light-tap skill.

Schematically, within a preset time period, a second attack operation is received upon receiving at least one first attack operation, where the second attack operation is an attack operation for automatically determining a to-be-attacked battle virtual object, for example, implemented as an operation of performing a light-tap operation for a non-light-tap skill, and the non-light-tap skill is capable of achieving a virtual attack effect.

Operation 1420: Determine whether a battle virtual object with a minimum health point is found among battle virtual objects with advanced markers.

Schematically, a target locking rule indicates, for example, searching for a battle virtual object with a minimum health point. Based on a first attack range corresponding to the second attack operation, the first attack range is first searched for battle virtual objects with advanced markers. If found, the following operation 1421 is performed. If not found, the following operation 1430 is found.

Operation 1421: Lock the battle virtual object with the minimum health point and an advanced marker.

Schematically, if battle virtual objects with advanced markers are found within the first attack range, the battle virtual object with the minimum health point is taken as the target virtual object targeted by the second attack operation.

Operation 1430: Find a battle virtual object with a minimum health point among battle virtual objects with normal markers.

Schematically, if no battle virtual object with an advanced marker is found within the first attack range, the first attack range is searched for battle virtual objects with normal markers. If found, the following operation 1431 is performed. If not found, the following operation 1440 is found.

Operation 1431: Lock the battle virtual object with the minimum health point and a normal marker.

Schematically, if a battle virtual object with a normal marker and the minimum health point is found within the first attack range, the battle virtual object is taken as the target virtual object targeted by the second attack operation.

Operation 1440: Search for a battle virtual object with a minimum health point among unmarked battle virtual objects.

Schematically, if no battle virtual object with a normal marker is found within the first attack range, a battle virtual object with a minimum health point is searched among unmarked battle virtual objects. If yes, the following operation 1441 is performed. If no, the following operation 1450 is performed.

Operation 1441: Lock the unmarked battle virtual object with the minimum health point.

Schematically, if unmarked battle virtual objects are found within the first attack range, the battle virtual object with the minimum health point is taken as the target virtual object.

Operation 1450: Do not release or release toward a facing direction.

Schematically, if no battle virtual object with the minimum health point can be found within the first attack range, the skill may not be released, or the skill may be released toward a facing direction of a master virtual object.

In an embodiment, in addition to the three-level structure, a marker clearing manner may be used. To be specific, when a skill is released, “markers” are first attached to battle virtual objects within the marking range. When the skill actually hits the first virtual object, all “markers” on the “marked” battle virtual objects are cleared, and a new “marker” is attached to a damaged battle virtual object.

To be specific, the damaged battle virtual object still retains the highest priority.

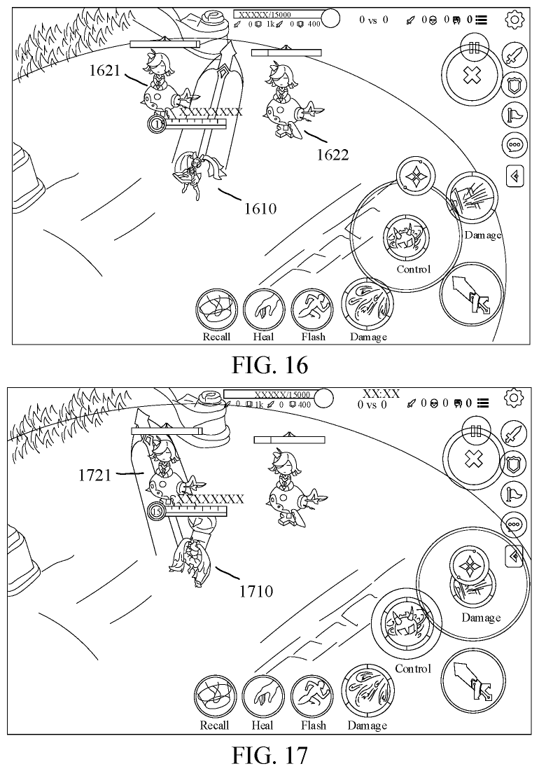

In some embodiments, FIG. 15 shows results corresponding to events occurring at different times and player operations.

On a timeline 1510 from skill release to termination, at time 1511, a player presses a first skill, meaning that a terminal receives a first attack operation, and object markers may be attached in the background to battle virtual objects within a marking range. At time 1512, a bullet is generated and launched. For example, the skill starts releasing from a master virtual object. At time 1513, the bullet hits and takes effect, all existing object markers are removed, and a new object identifier is attached to the hit battle virtual object. For example, the skill arrives at a first virtual object targeted by a first attack operation.

If the player presses a second skill between time 1511 and time 1512, to be specific, the terminal receives a second attack operation between time 1511 and time 1512, normal target locking will be performed based on the object markers.

If the player presses the second skill between time 1512 and time 1513, to be specific, the terminal receives the second attack operation between time 1512 and time 1513, normal target locking can still be achieved based on the corresponding object markers within the marking range even if the bullet has not hit during flight. Alternatively, normal target locking is still available even if the bullet misses.

If the player presses the second skill after time 1513, to be specific, the terminal receives the second attack operation after time 1513, normal target locking can still be performed through the removal of object markers within the marking region and comparison of re-marked objects of the hit battle virtual object.

In some embodiments, as shown in FIG. 16, a master virtual object 1610 intends to attack a battle virtual object 1621 based on a first attack operation, but the process results in a miss. When a second attack operation is received within a preset time period required for a combo, since the battle virtual object 1621 is within a marking range while a battle virtual object 1622 is not within the marking range, an effect shown in FIG. 17 can be achieved. To be specific, the master virtual object 1710 automatically determines a battle virtual object 1721 as a target virtual object to be attacked based on the second attack operation, thereby presenting the master virtual object attacking the target virtual object.

To be specific, even when no bullet has been generated, the bullet is still in flight, or the skill release results in a miss, light-tap target locking can still attack the battle virtual object intended to be attacked by the player, thereby optimizing the skill release experience of the player and reducing release of reversed skills and unintended skills.

The foregoing descriptions are only illustrative examples. This is not limited in the embodiments of this disclosure.

In summary, in combination with a first virtual object targeted by a previous first attack operation of a player, a target virtual object to be attacked may be automatically determined from a plurality of battle virtual objects in a manner more in line with a condition expected by the player, thereby improving the accuracy of selecting the target virtual object, saving computing resources during a game, helping ensure the precision and fluency of automatic object selection, and enhancing human-computer interaction efficiency during the game while improving the gaming experience of the player.

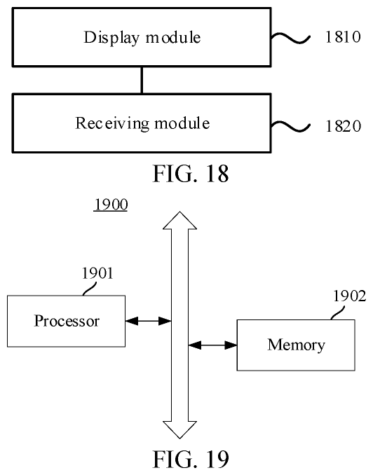

FIG. 18 is a structural block diagram of an apparatus for controlling objects in a virtual scene according to an example embodiment of this disclosure. As shown in FIG. 18, the apparatus includes the following components:

a display module 1810, configured to display a master virtual object and at least two battle virtual objects in a virtual scene, the master virtual object being configured to perform a virtual battle with the battle virtual objects in the virtual scene; and

a receiving module 1820, configured to receive a first attack operation, the first attack operation being configured for attacking at least one first virtual object in the at least two battle virtual objects.

The receiving module 1820 is further configured to receive a second attack operation, the second attack operation corresponding to a first attack range, and the second attack operation being configured for automatically determining a to-be-attacked battle virtual object within the first attack range.

The display module 1810 is further configured to display, in response to the second attack operation, the master virtual object attacking a target virtual object in the at least two battle virtual objects based on a positional relationship between the first virtual object and the first attack range, the target virtual object being the same as the first virtual object, or the target virtual object being different from the first virtual object.

In an embodiment, the display module 1810 is further configured to display, in a case that the first virtual object is within the first attack range, the master virtual object attacking the target virtual object in response to the second attack operation, the target virtual object being a battle virtual object in the at least one first virtual object.

In an embodiment, the display module 1810 is further configured to: display, in a case that the first virtual object is within the first attack range, the master virtual object attacking a first virtual object with a minimum virtual health value, the first virtual object with the minimum virtual health value being the target virtual object; or display, in a case that the first virtual object is within the first attack range, the master virtual object attacking a first virtual object with the shortest object distance, the first virtual object with the shortest object distance being the target virtual object.

In an embodiment, the display module 1810 is further configured to display, in a case that the first virtual object corresponding to the first attack operation does not exist within the first attack range, the master virtual object attacking the target virtual object in response to the second attack operation, the target virtual object being a battle virtual object, different from the first virtual object, among the plurality of battle virtual objects.

In an embodiment, the first attack operation corresponds to a second attack range and a marking range, the second attack range being a sub-region range within the marking range.

The display module 1810 is further configured to display, in a case that the first virtual object is not within the first attack range and the first attack range includes a second virtual object within the marking range, the master virtual object attacking the second virtual object in response to the second attack operation, the target virtual object including the second virtual object.

In an embodiment, the display module 1810 is further configured to display, in a case that the first virtual object is not within the first attack range and the first attack range does not include a second virtual object within the marking range, the master virtual object attacking a third virtual object in response to the second attack operation, the target virtual object including the third virtual object, and the third virtual object being within the first attack range but not within the marking range and being not the first virtual object.

In an embodiment, the display module 1810 is further configured to: add, based on the first attack operation, a first object identifier to the battle virtual object within the marking range; determine, in a case that the first virtual object is not within the first attack range, the battle virtual object marked with the first object identifier within the second attack range as the second virtual object; and display the master virtual object attacking the second virtual object.

In an embodiment, the display module 1810 is further configured to: add, in response to the first attack operation inflicting an attack damage to a fourth virtual object in the at least one first virtual object, a second object identifier to the fourth virtual object within the second attack range, a priority of the second object identifier being higher than that of the first object identifier; determine, in response to the second attack operation, the fourth virtual object marked with the second object identifier within the first attack range; and display the master virtual object attacking the fourth virtual object.

In an embodiment, the receiving module 1820 is further configured to: receive a first trigger operation for a first attack control as the first attack operation, the first attack control having an object designation function, the object designation function being configured for designating the first virtual object from at least two battle virtual objects, and the first trigger operation being an operation of attacking the first virtual object based on the object designation function; or receive a second trigger operation for the first attack control as the first attack operation, the second trigger operation being an operation of automatically determining the first virtual object by using the first attack control.

In an embodiment, the receiving module 1820 is further configured to display, based on the first attack operation, the master virtual object attacking the first virtual object.

In an embodiment, the display module 1810 is further configured to display, in response to the second attack operation being an attack operation received within a preset time period following the first attack operation, the master virtual object attacking a target virtual object in the at least two battle virtual objects based on a positional relationship between the first virtual object and the first attack range, the second attack operation received within the preset time period and the first attack operation being combo attack operations.

In summary, in combination with a first virtual object targeted by a previous first attack operation of a player, a target virtual object to be attacked may be automatically determined from a plurality of battle virtual objects in a manner more in line with player expectations, thereby improving the accuracy of selecting the target virtual object, saving computing resources during a game, helping ensure the precision and fluency of automatic object selection, and enhancing human-computer interaction efficiency during the game while improving the gaming experience of the player.

The apparatus for controlling objects in a virtual scene provided in the foregoing embodiments is described only using the division of the foregoing functional modules as an example. In practice, the foregoing functions may be allocated to and completed by different functional modules as required. To be specific, an internal structure of a device is divided into different functional modules to complete all or some of the functions described above. In addition, the apparatus for controlling objects in a virtual scene provided in the foregoing embodiments belongs to the same conception as the embodiments of the method for controlling objects in a virtual scene. For a specific implementation process thereof, refer to the method embodiments. Details are not described herein again.

FIG. 19 shows a structural block diagram of an electronic device 1900 according to an example embodiment of this disclosure. The electronic device 1900 may be a portable mobile terminal, for example, a smartphone, an in-vehicle terminal, a tablet computer, an MP3 player, an MP4 player, a laptop computer, or a desktop computer. The electronic device 1900 may alternatively be referred to as other names such as user equipment, a portable terminal, a laptop terminal, or a desktop terminal.

Generally, the electronic device 1900 includes a processor 1901 and a memory 1902.

The processor 1901 may include one or more processing cores, for example, a 4-core processor or an 8-core processor. The processor 1901 may be implemented in at least one hardware form of digital signal processing (DSP), a field-programmable gate array (FPGA), and a programmable logic array (PLA). The processor 1901 may alternatively include a main processor and a co-processor. In some embodiments, the processor 1901 may be integrated with a graphics processing unit (GPU). The GPU is configured to render and draw content that needs to be displayed on a display screen. In some embodiments, the processor 1901 may further include an artificial intelligence (AI) processor. The AI processor is configured to perform computing operations related to machine learning.

The memory 1902 may include one or more computer-readable storage media. The computer-readable storage medium may be non-transient.

In some embodiments, the electronic device 1900 further includes one or more sensors. The one or more sensors include, but are not limited to, a proximity sensor, a gyro sensor, and a pressure sensor.

In some embodiments, the electronic device 1900 further includes another component. A person skilled in the art may understand that the structure shown in FIG. 19 does not constitute a limitation to the electronic device 1900, and the electronic device may include more or fewer components than those shown in the figure, or some components may be combined, or a different component deployment may be used.

Embodiments of this disclosure further provide a computer device. The computer device may be implemented as the terminal or the server shown in FIG. 2. The computer device includes a processor and a memory. The memory has at least one instruction, at least one program, a code set, or an instruction set stored therein. The at least one instruction, the at least one program, the code set, or the instruction set is loaded and executed by the processor to implement the method for controlling objects in a virtual scene according to the foregoing method embodiments.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Embodiments of this disclosure further provide a non-transitory computer-readable storage medium. The non-transitory computer-readable storage medium has at least one instruction, at least one program, a code set, or an instruction set stored therein. The at least one instruction, the at least one program, the code set, or the instruction set is loaded and executed by a processor to implement the method for controlling objects in a virtual scene according to the foregoing method embodiments.

Embodiments of this disclosure further provide a computer program product or a computer program. The computer program product or the computer program includes computer instructions. The computer instructions are stored in a non-transitory computer-readable storage medium. A processor of a computer device reads the computer instructions from the non-transitory computer-readable storage medium, and the processor executes the computer instructions, to cause the computer device to perform the method for controlling objects in a virtual scene according to any one of the foregoing embodiments. A person of ordinary skill in the art may understand that all or part of the operations of implementing the foregoing embodiments may be implemented by hardware, or may be implemented by a program instructing related hardware. The program may be stored in a non-transitory computer-readable storage medium. The foregoing storage medium may be a read-only memory, a magnetic disk, an optical disc, or the like.

The foregoing descriptions are merely example embodiments of this disclosure, but are not intended to limit this disclosure. Any modification, equivalent replacement, or improvement made within the spirit and principle of this disclosure is required to fall within the scope of this disclosure.

What is claimed is:

1. A virtual object-controlling method, the method comprising:
displaying a master virtual object and at least two battle virtual objects in a virtual scene;
receiving a first user input associated with a first attack operation for attacking at least a first virtual object of the at least two battle virtual objects;
receiving a second user input associated with a second attack operation, the second attack operation being configured to automatically determine a to-be-attacked battle virtual object within a first attack range; and
displaying, based on the second attack operation, the master virtual object attacking a target virtual object of the at least two battle virtual objects based on whether the first virtual object is within the first attack range, the target virtual object including the first virtual object or a different virtual object from the first virtual object.

2. The method according to claim 1, wherein the displaying the master virtual object attacking the target virtual object comprises:
displaying, when the first virtual object is within the first attack range, the master virtual object attacking the first virtual object based on the second attack operation, the target virtual object comprising a battle virtual object in the first virtual object.

3. The method according to claim 1, wherein the displaying the master virtual object attacking the first virtual object comprises at least one of:
displaying, when the first virtual object is within the first attack range, the master virtual object attacking a first virtual object with a minimum virtual health value, the first virtual object with the minimum virtual health value comprising the target virtual object; or
displaying, when the first virtual object is within the first attack range, the master virtual object attacking a first virtual object within a shortest object distance, the first virtual object with the shortest object distance comprising the target virtual object.

4. The method according to claim 1, wherein the displaying the master virtual object attacking a target virtual object comprises:
displaying, when the first virtual object corresponding to the first attack operation is not within the first attack range, the master virtual object attacking the different virtual object.

5. The method according to claim 1, wherein the first attack operation corresponds to a second attack range and a marking range, the second attack range comprising a sub-region range within the marking range; and
the displaying the master virtual object attacking a target virtual object comprises:
displaying, when the first virtual object is not within the first attack range and the first attack range comprises a second virtual object within the marking range, the master virtual object attacking the second virtual object based on the second attack operation, the target virtual object comprising the second virtual object.

6. The method according to claim 5, wherein the displaying the master virtual object attacking the target virtual object comprises:
displaying, when the first virtual object is not within the first attack range and the first attack range does not comprise a second virtual object within the marking range, the master virtual object attacking a third virtual object based on the second attack operation, the target virtual object comprising the third virtual object, and the third virtual object being within the first attack range but not within the marking range and not comprising the first virtual object.

7. The method according to claim 5, further comprising:
adding, based on the first attack operation, a first object identifier to the second virtual object within the marking range,
wherein the displaying the master virtual object attacking the second virtual object comprises:
determining, when the first virtual object is not within the first attack range, the second virtual object marked with the first object identifier within the second attack range as the to-be-attacked battle virtual object; and
displaying the master virtual object attacking the second virtual object.

8. The method according to claim 7, further comprising:
adding, based on the first attack operation inflicting an attack damage to a fourth virtual object in the first virtual object, a second object identifier to the fourth virtual object within the second attack range, a priority of the second object identifier being higher than that of the first object identifier,
wherein the displaying the master virtual object attacking the target virtual object comprises:
determining, based on the second attack operation, the fourth virtual object marked with the second object identifier within the first attack range; and
displaying the master virtual object attacking the fourth virtual object.

9. The method according to claim 1, wherein the receiving the first user input associated with the first attack operation comprises at least one of:
receiving a first trigger operation for a first attack control as the first user input, the first attack control having an object designation function, the object designation function being configured to designate the first virtual object from at least two battle virtual objects, and the first trigger operation being an operation of attacking the first virtual object based on the object designation function; or
receiving a second trigger operation for the first attack control as the first user input, the second trigger operation comprising an operation of automatically determining the first virtual object by using the first attack control.

10. The method according to claim 1, further comprising:
displaying, based on the first attack operation, the master virtual object attacking the first virtual object.

11. The method according to claim 1, wherein the displaying the master virtual object attacking the target virtual object comprises:
displaying, based on the second user input being received within a preset time period of the first user input, the master virtual object attacking a target virtual object in the at least two battle virtual objects based on a positional relationship between the first virtual object and the first attack range, the second attack operation received within the preset time period and the first attack operation being combo attack operations.

12. A virtual object-controlling apparatus, the apparatus comprising:
processing circuitry configured to:
display a master virtual object and at least two battle virtual objects in a virtual scene;
receive a first user input associated with a first attack operation for attacking at least a first virtual object of the at least two battle virtual objects;
receive a second user input associated with a second attack operation, the second attack operation being configured to automatically determine a to-be-attacked battle virtual object within a first attack range; and
display, based on the second attack operation, the master virtual object attacking a target virtual object of the at least two battle virtual objects based on whether the first virtual object is within the first attack range, the target virtual object including the first virtual object or a different virtual object from the first virtual object.

13. The virtual object-controlling apparatus of claim 12, wherein the display the master virtual object attacking the target virtual object comprises:
display, when the first virtual object is within the first attack range, the master virtual object attacking the first virtual object based on the second attack operation, the target virtual object comprising a battle virtual object in the first virtual object.

14. The virtual object-controlling apparatus of claim 12, wherein the display the master virtual object attacking the first virtual object comprises at least one of:
display, when the first virtual object is within the first attack range, the master virtual object attacking a first virtual object with a minimum virtual health value, the first virtual object with the minimum virtual health value comprising the target virtual object; or
display, when the first virtual object is within the first attack range, the master virtual object attacking a first virtual object within a shortest object distance, the first virtual object with the shortest object distance comprising the target virtual object.

15. The virtual object-controlling apparatus of claim 12, wherein the display the master virtual object attacking a target virtual object comprises:
display, when the first virtual object corresponding to the first attack operation is not within the first attack range, the master virtual object attacking the different virtual object.

16. The virtual object-controlling apparatus of claim 12, wherein the first attack operation corresponds to a second attack range and a marking range, the second attack range comprising a sub-region range within the marking range; and
the display the master virtual object attacking a target virtual object comprises:
display, when the first virtual object is not within the first attack range and the first attack range comprises a second virtual object within the marking range, the master virtual object attacking the second virtual object based on the second attack operation, the target virtual object comprising the second virtual object.

17. The virtual object-controlling apparatus of claim 16, wherein the display the master virtual object attacking the target virtual object comprises:
display, when the first virtual object is not within the first attack range and the first attack range does not comprise a second virtual object within the marking range, the master virtual object attacking a third virtual object based on the second attack operation, the target virtual object comprising the third virtual object, and the third virtual object being within the first attack range but not within the marking range and not comprising the first virtual object.

18. The virtual object-controlling apparatus of claim 16, wherein the processing circuitry is configured to:
add, based on the first attack operation, a first object identifier to the second virtual object within the marking range,
wherein the display the master virtual object attacking the second virtual object comprises:
determine, when the first virtual object is not within the first attack range, the second virtual object marked with the first object identifier within the second attack range as the to-be-attacked battle virtual object; and
display the master virtual object attacking the second virtual object.

19. The virtual object-controlling apparatus of claim 18, wherein the processing circuitry is configured to:
add, based on the first attack operation inflicting an attack damage to a fourth virtual object in the first virtual object, a second object identifier to the fourth virtual object within the second attack range, a priority of the second object identifier being higher than that of the first object identifier,
wherein the display the master virtual object attacking the target virtual object comprises:
determine, based on the second attack operation, the fourth virtual object marked with the second object identifier within the first attack range; and
display the master virtual object attacking the fourth virtual object.

20. A non-transitory computer-readable storage medium storing instructions which when executed by a processor cause the processor to perform:
displaying a master virtual object and at least two battle virtual objects in a virtual scene;
receiving a first user input associated with a first attack operation for attacking at least a first virtual object of the at least two battle virtual objects;
receiving a second user input associated with a second attack operation, the second attack operation being configured to automatically determine a to-be-attacked battle virtual object within a first attack range; and
displaying, based on the second attack operation, the master virtual object attacking a target virtual object of the at least two battle virtual objects based on whether the first virtual object is within the first attack range, the target virtual object including the first virtual object or a different virtual object from the first virtual object.
